(19) United States
(12) Patent Application Publication
(10) Pub. No.: US 2025/0179613 A1
(43) Pub. Date: Jun. 5, 2025

(54) PROCESSES AND METHODS FOR RECOVERING RARE EARTH ELEMENTS AND SCANDIUM FROM ACIDIC SOLUTIONS

(71) Applicant: NIOCORP DEVELOPMENTS LTD., Centennial, CO (US)

(72) Inventors: Tommee LAROCHELLE, Bent Mountain, VA (US); Eric F. LAROCHELLE, West Jordan, UT (US); Steeve LAFONTAINE, Trois-Rivieres (CA); Rick SIXBERRY, Boulder City, NV (US); Kelton Trent SMITH, Parker, CO (US); Scott HONAN, Centennial, CO (US)

(21) Appl. No.: 19/037,952

(22) Filed: Jan. 27, 2025

Related U.S. Application Data
(63) Continuation of application No. PCT/US2023/071316, filed on Jul. 31, 2023.
(60) Provisional application No. 63/394,211, filed on Aug. 1, 2022.

(51) Int. Cl. C22B 60/02; C22B 3/10; C22B 3/26; C22B 59/00

(52) U.S. Cl. CPC C22B 60/0291; C22B 3/10; C22B 3/26; C22B 59/00

(57) ABSTRACT

The present disclosure is directed to processes and methods for recovering rare earth elements and scandium from acidic solutions. Transition metals, lanthanum, cerium, actinides, thorium, or a combinations thereof may be selectively removed from a lanthanide and transition metal comprising solution via the use of an extractant and an alkali compound, such as magnesium chloride to recover valuable rare earth elements. In an embodiment, a lanthanide-comprising solution is contacted with an extractant to form a raffinate and a loaded organic comprising most of the lanthanides and one or more transition metals. At least a portion of the transition metals is removed from the loaded organic based on the alkali compound, forming a transition metal-rich solution and a transition metal scrubbed organic, and at least a portion of the lanthanides are removed from the transition metal scrubbed organic based on the alkali compound to form a lanthanide liquor.

### CROSS REFERENCE TO RELATED APPLICATIONS

This application is a continuation application of International Application No. PCT/US2023/071316 having an international filing date of 31 Jul. 2023, which designated the United States, and which PCT application claimed the benefit of U.S. Provisional Application No. 63/394,211 filed Aug. 1, 2022, entitled “PROCESS AND METHOD FOR RECOVERING RARE EARTH ELEMENTS AND SCANDIUM FROM ACIDIC SOLUTIONS,” the disclosure of each of which are incorporated herein by reference in their entirety.

### FIELD

The disclosure relates generally to the recovery of rare earth elements (REEs) and particularly to the recovery of REEs from acidic solutions.

### BACKGROUND

The lanthanide series of chemical elements comprises the fifteen metallic chemical elements with atomic numbers 57-71, from lanthanum through lutetium. These elements, along with the chemically similar elements scandium and yttrium, are often collectively known as the rare-earth elements or rare-earth metals.

The lanthanides have many scientific and industrial uses. For example, lanthanides have been widely used as alloys to impart strength and hardness to metals. Lanthanides are also widely used in the petroleum industry for refining crude oil into gasoline products and/or as a catalyst in the manufacture of petroleum and synthetic products. Other uses of lanthanides may include, but are not limited to, production of flat-screen TVs, cell phones, electric cars, hybrid car batteries, satellites, lamps, magnets, lasers, motion picture projectors, and X-ray screens, etc.

Rare-earth elements are often found in ores as impurities alongside many transition metal elements. Because of their relatively low concentrations, and similar behavior to more common elements, their separation from those elements is expensive and results in a significant environmental footprint.

Many processes are used industrially to extract rare earth elements from ores, relying on an acid leach followed by the precipitation of impurities through oxidation and neutralization. Typically, iron (II) is oxidized to iron (III) and is first precipitated in the pH range 2.1 to 3.5, followed by aluminum in the pH range 3.5 to 4.5.

Unfortunately, these processes tend to consume large amounts of acid, which in turn required large amounts of alkali as neutralization agents. Additionally, in the neutralization step, scandium tend to coprecipitate with aluminum along with yttrium and to a lesser extent heavy rare earths, resulting in a significant loss of scandium and of other rare earth elements.

The rare earth elements are then extracted from the solution alongside other elements such as zinc and separated in a solvent extraction circuit.

Solvent extraction is a process in which a metal-rich aqueous phase (comprising rare earth elements) is brought into contact with an immiscible organic phase, containing an extractant, a diluent and often also a modifier. The extractant may be a metal-coordinating ligand and the diluent may be used to increase the solubility of the complex and to decrease the viscosity of the organic phase. The metals distribute between the two phases (i.e., the organic and aqueous phases) based on their affinity for the aqueous phase (interactions with water and/or the complexing agent) or the organic phase (interactions with the extractant and/or the diluent). Among other advantages, this form of separation can be continuously operated and can lead to substantial production capacity. In general, extractants are divided in three distinct classes: (1) acidic extractants for which the extraction is pH-dependent, (2) neutral extractants, where neutral species containing electron-donating groups such as oxygen coordinate to the metal ion, and (3) basic extractants which extract anionic metal complexes. Such solvent extraction processes, however, additionally require a large amount of acid and base solvents to perform the desired separation as transition metals (e.g., iron, aluminum, and zinc) have more affinity for the organic as compared to the rare earth elements and therefore, “clog” the organic.

There is a need for a lanthanide recovery process that minimizes the losses of scandium, yttrium and heavy rare earth while reducing the amount of acid and alkali consumed in the extraction process.

### SUMMARY

These and other needs are addressed by the various embodiments and configurations of the present disclosure.

The present disclosure is directed generally to extracting rare earth elements (REEs), including but not limited to lanthanides from rare earth-comprising ores. Specifically, the present disclosure is directed to processes and methods for recovering valuable rare earth elements, such as scandium, from acidic solutions (e.g., a pregnant leach solution (PLS)) by selectively removing transition metals (e.g., iron), lanthanum, cerium, actinides, thorium, or combinations thereof from the acidic solutions.

In some embodiments, the processes and methods of the present disclosure use diglycoamide (DGA) extractants, a class of organic extractant, for the selective bulk extraction of lanthanide(s) (Ln). The processes and methods of the present disclosure may achieve the bulk extraction of lanthanides by selectively removing compounds other than lanthanides, such as transition metals, from a lanthanide-comprising solution until a lanthanide liquor is formed. The present disclosure provides various approaches to separating the valuable lanthanides from transition metals while substantially minimizing the wastewater volume and acid and reagent usage.

In a non-limiting embodiment, a DGA circuit of the present disclosure may include extracting lanthanides and other metals to an organic phase from an acidic feed solution (e.g., a PLS feed, a feed from one or more other processes such as a tributyl phosphate (TBP) circuit described herein, one or more other DGA circuits described herein). Non-lanthanide metals (e.g., iron, magnesium, other transition metals) may be stripped from the organic phase resulting in a non-lanthanide metal strip solution and a lanthanide-comprising organic phase stripped of one or more non-lanthanide metals. The non-lanthanide metal strip solution may be recycled back to the extraction step and/or directed to another unit or process for further processing, such as metal precipitation. At least a portion of the lanthanide(s) in the lanthanide-comprising organic may be stripped or scrubbed from the lanthanide-comprising organic by a lanthanide strip solution resulting in a lanthanide liquor. In some embodiments, the DGA circuit may include any number of additional steps, units, equipment, etc. For example, the non-lanthanide metals may be removed from lanthanide-comprising streams in multiple units or steps, such as one or more stripping steps, one or more scrubbing steps, and/or one or more precipitating steps. In another example, lanthanides may be recovered in one or more units or steps, such as in a lanthanide strip unit where lanthanides are stripped from the organic phase, and/or a lanthanide scrub extraction where lanthanides are extracted from a lanthanide scrub solution. In some embodiments, one or more streams in a DGA circuit of the present disclosure may be recycled, including but limited to a DGA extractant, a metal strip solution, a scrubbed organic solution, and a lanthanide scrub solution.

One non-limiting example of a DGA extractant comprises dimethyl, di-octyl diglycolamide (DMDODGA) which offers the highest extraction potential of all currently investigated DGA compounds. Another non-limiting example of a DGA extractant, includes di-methyloctyl dihexyl diglycolamide (DMODHDGA, DG6). DMDODGA, in some embodiments, may also co-extract compounds other than lanthanides, such as iron and magnesium, and DMDODGA's complete stripping may require low ionic strength solutions or prestripitation. Experiments associated with the present disclosure demonstrated DG6 had an improved commercial potential due to its lower propensity for organic phase partitioning, resulting in two organic phases in the system. Therefore, it may be beneficial, in some embodiments, to utilize DG6 over DMDODGA. Although, it should be understood that the processes and methods of the present disclosure may utilize any one or more DGA compounds for extracting lanthanides by selectively removing compounds other than lanthanides from a lanthanide-comprising solution until a lanthanide liquor remains. In some embodiments, a DGA extractant comprises a combination of DGA compounds, such as DMDODGA and DG6.

In an embodiment of the present disclosure, iron is selectively removed from an organic phase without the typical loss of rare earth elements by adding magnesium in particular amounts (via a strip or scrub solution).

In another embodiment of the present disclosure, iron is selectively removed from an organic phase alongside thorium, lanthanum and cerium without losses of any other rare earth elements including praseodymium and neodymium by adding magnesium in particular amounts (via a strip or scrub solution).

In another embodiment of the present disclosure, thorium is selectively removed from an organic phase alongside lanthanum and cerium without losses of any other rare earth elements including praseodymium and neodymium by adding magnesium in particular amounts (via a strip or scrub solution). The DGA circuits of the present disclosure are performed at high acidity, with reduced or without any neutralization of the pregnant leach feed solution. The rare earth elements are recovered with a low acid solution, as opposed to a high acid solution in conventional lanthanide recovery circuits.

The present disclosure additionally provides a tributyl phosphate (TBP) extraction circuit for selectively removing iron from an acid feed solution. For example, the TBP circuit may selectively recover iron from impurities, such as one or more transition metals and the lanthanides, in the acidic feed solution. The TBP extraction circuit may be used standalone, or in combination with any other lanthanide extraction process, including but not limited to the lanthanide extraction processes described herein. For example, the TBP extraction circuit may be positioned ahead of one or more of the other lanthanide recovery circuits described herein to improve efficiency of the overall lanthanide recovery system. For example, the TBP circuit may be used to selectively remove iron leaving behind lanthanides, scandium and/or thorium from a pregnant leach solution (PLS) prior to a DGA and/or DMDODGA rare earth element recovery circuit, which may allow for a reduction in the size of the DGA and/or DMDODGA circuit needed to achieve target recovery.

In a non-limiting example, a TBP circuit as disclosed herein may include extracting iron (Fe), lanthanide(s), scandium (Sc), thorium (Th), and other metals to an organic phase from an acidic feed solution (e.g., PLS). The scandium, lanthanide(s), and thorium may then be stripped from the organic phase into a scrub solution in a lanthanide scrubbing step and the iron may be selectively stripped from the organic phase into an iron strip solution in an iron strip step. The lanthanide scrub and iron strip may occur simultaneously or sequentially. In some embodiments, the lanthanides may be removed from the organic first and then the iron may be removed, or vice versa. In some embodiments, a TBP extractant may be recycled. The recycled TBP extractant may be in the form of a stripped organic solution comprising the

TBP extractant. In some embodiments, one or more output streams from the TBP circuit may be fed as inputs to one or more DGA circuits described herein, such as output streams comprising lanthanides.

In aspects of the present disclosure, the recovery methods and processes include the steps of:
(a) contacting an organic solution comprising one or more rare earth elements and one or more of base metals and thorium with an acidic solution to selectively remove at least most of the base metals and thorium to form a base metal-rich acidic solution and a base metal-scrubbed organic solution comprising the rare earth elements; and
(b) contacting the base metal-rich acidic solution with a precipitation agent to remove at least most of the base metals and thorium to form a base metal-stripped acidic solution and solids comprising the base metals and thorium.

In embodiments, the methods and processes further comprise recycling, to step (a), the base metal-stripped acidic solution for at least partial use as the acidic solution.

In embodiments, at least most of the rare earth elements from the organic solution are maintained in the base metal-scrubbed organic solution after the contacting of step (a).

In embodiments, the base metal-scrubbed organic solution is substantially free of the one or more of base metals and thorium.

In embodiments, the acidic solution comprises one or more alkali compounds, the one or more alkali compounds comprising sodium, potassium, magnesium, calcium, strontium, ammonium, or combinations thereof.

In embodiments, the one or more alkali compounds are in the form of a salt, and wherein the salt is a chloride or a nitrate salt selected from the group comprising magnesium chloride, calcium chloride, strontium chloride, ammonium chloride, sodium chloride, magnesium nitrate, calcium nitrate, strontium nitrate, ammonium nitrate, sodium nitrate, or combinations thereof.

In embodiments, the precipitation agent is an alkali compound comprising sodium, potassium, magnesium, calcium, strontium or ammonium.

In embodiments, the precipitation agent is a carbonate, an oxide, a hydroxide, or an oxychloride.

In embodiments, the method and processes further comprise contacting, prior to step (a), a pregnant leach solution comprising the rare earth elements with a diglycoamide (DGA) extractant to form a raffinate and the organic solution, wherein the organic solution comprises at least most of the rare earth elements from the pregnant leach solution.

In embodiments, the rare earth elements comprise yttrium, terbium, europium, thulium, ytterbium, praseodymium, dysprosium, gadolinium, lutetium, promethium, scandium, neodymium, samarium, erbium, holmium, or combinations thereof.

In embodiments, the base metals comprise iron (Fe), titanium (Ti), niobium (Nb), vanadium (V), chromium (Cr), cobalt (Co), nickel (Ni), zirconium (Zr), aluminum (Al), or combinations thereof.

In aspects of the present disclosure, the recovery methods and processes include the steps of:
a) contacting an organic solution comprising one or more lanthanides and one or more of base metals and thorium with an alkali comprising solution to selectively remove at least most of the base metals and thorium to form a base metal-rich alkali comprising solution and a base metal-scrubbed organic solution comprising the lanthanides;
(b) contacting the base metal-rich alkali comprising solution with a precipitation agent to form a base metal-stripped alkali comprising solution and solids comprising the base metals and thorium; and
(c) recycling, to step (a), the base metal-stripped alkali comprising solution.

In embodiments, in step (b), at least most of the base metals and thorium of the base metal-rich solution are precipitated into the solids.

In embodiments, at least most of the lanthanides from the organic solution are maintained in the base metal-scrubbed organic solution after the contacting of step (a).

In embodiments, at least a portion of the alkali comprising solution in step (a) comprises the base metal-stripped alkali comprising solution recycled from step (c).

In embodiments, the alkali comprising solution comprises one or more alkali compounds, the one or more alkali compounds comprising sodium, potassium, magnesium, calcium, strontium, ammonium, or combinations thereof, and wherein the one or more alkali compounds are in the form of a chloride or nitrate salt, selected from the group comprising magnesium chloride, calcium chloride, strontium chloride, ammonium chloride, sodium chloride, magnesium nitrate, calcium nitrate, strontium nitrate, ammonium nitrate, sodium nitrate, or combinations thereof.

In embodiments, the methods and processes further comprises contacting, prior to step (a), a pregnant leach solution comprising the lanthanides with a diglycoamide (DGA) extractant to form a raffinate and the organic solution, wherein the organic solution comprises at least most of the lanthanides from the pregnant leach solution.

In aspects of the present disclosure, the recovery methods and processes include the steps of:
(a) contacting an organic solution comprising one or more rare earth elements and one or more of base metals and thorium with a first alkali-comprising solution to selectively remove at least most of the base metals and thorium to form a base metal-rich alkali solution and a base metal-scrubbed organic solution comprising the rare earth elements;
(b) contacting the base metal-rich alkali solution with a precipitation agent to remove at least most of the base metals and thorium to form a base metal-stripped alkali solution and solids comprising the base metals and thorium;
(c) recycling, to step (a), the base metal-stripped alkali solution; and
(d) contacting the base metal-scrubbed organic solution with a rare earth stripping solution comprising a second alkali-comprising solution to remove at least most of the rare earth elements from the base metal-scrubbed organic solution.

In embodiments, at least most of the rare earth elements from the organic solution are maintained in the base metal-scrubbed organic solution after the contacting of step (a).

In embodiments, at least a portion of the first alkali-comprising solution in step (a) comprises the base metal-stripped alkali solution recycled from step (c).

In embodiments, the first and/or second alkali-comprising solutions comprises sodium, potassium, magnesium, calcium, strontium or ammonium and are in the form of a salt, wherein the salt is a chloride or a nitrate salt such as magnesium chloride, calcium chloride, strontium chloride, ammonium chloride, sodium chloride, magnesium nitrate, calcium nitrate, strontium nitrate, ammonium nitrate, sodium nitrate, or combinations thereof, and wherein the first and second alkali-comprising solutions are the same.

In embodiments, the methods and processes further comprise contacting, prior to step (a), a pregnant leach solution comprising the rare earth elements with a diglycoamide (DGA) extractant to form a raffinate and the organic solution, wherein the organic solution comprises at least most of the rare earth elements from the pregnant leach solution.

In some embodiments, the recovery methods and processes include the steps of:
a) contacting a pregnant leach solution comprising lanthanides and transition metals with a diglycoamide (DGA) extractant to form a raffinate and a loaded organic, wherein the loaded organic comprises at least most of the lanthanides and the transition metals;
b) contacting the loaded organic with a transition metal stripping solution comprising a first alkali compound to remove at least most of the transition metals from the loaded organic and form a transition metal-rich solution and a transition metal scrubbed organic comprising the lanthanides; and
c) contacting the transition metal scrubbed organic with a lanthanide stripping solution comprising a second alkali compound to remove at least most of the lanthanides from the transition metal scrubbed organic and form a barren DGA extractant and a lanthanide liquor comprising at least most of the lanthanides.

The first and/or second alkali compounds comprises sodium, potassium, magnesium, calcium, strontium or ammonium. The first and/or second alkali compounds are in the form of a salt, and wherein the salt is a chloride or a nitrate salt such as magnesium chloride, calcium chloride, strontium chloride, ammonium chloride, sodium chloride, magnesium nitrate, calcium nitrate, strontium nitrate, ammonium nitrate, sodium nitrate, or combinations thereof. The first and second alkali compound may be the same of different.

The processes and methods may further include recycling the DGA extractant of the contacting step (c) to the contacting step (a), wherein the DGA extractant in step (a) is the same as or is combined with the DGA extractant solution of step (c).

The processes and methods may further include recycling, prior to the contacting step (c), a first portion of the transition metal scrubbed organic to the contacting step (a), wherein a remaining portion of the transition metal scrubbed organic is directed to the contacting step (c).

The contacting in step (a), may further include contacting, in step (a), the pregnant leach solution and the DGA extractant with the transition metal-rich solution from the removing step (b).

The contacting step (b) may scrub at least about 15% of the transition metals from the loaded organic, and wherein at least most of the lanthanides are maintained in the loaded organic after the contacting step (b).

The contacting step (b) may scrub at least about 5% of lanthanum and cerium metals from the loaded organic, and wherein at least most of the remaining lanthanides are maintained in the loaded organic after the contacting step (b).

The contacting step (c) may scrub at least about 35% of the lanthanides from the transition metal scrubbed organic.

The pregnant leach solution may comprise actinides, wherein the loaded organic comprises at least most of the actinides, and wherein at least some of the actinides are removed from the loaded organic in the contacting step (b), and wherein at least most of the lanthanides are maintained in the loaded organic after the contacting step (b). The contacting step (b) may scrub at least about 15% of the actinides from the loaded organic. The actinides comprise actinium (Ac), thorium (Th), protactinium (Pa), uranium (U), neptunium (Np), plutonium (Pu), americium (Am), or combinations thereof.

The contacting step (b) may selectively scrub at least a portion of the transition metals, lanthanum, cerium, thorium, actinides, or a combination thereof from the loaded organic, and wherein at least most of the yttrium, terbium, europium, thulium, ytterbium, praseodymium, dysprosium, gadolinium, lutetium, promethium, scandium, neodymium, samarium, erbium, and holmium of the lanthanides are maintained in the loaded organic after the contacting step (b).

The processes and methods may further include:
d) contacting, prior to the contacting step (c), the transition metal scrubbed organic and a lanthanide scrubbing solution to form a lanthanide scrub liquor and a lanthanide scrubbed organic.

The processes and methods may further include contacting the lanthanide scrub liquor with a precipitation agent to form transition metal solids and a lanthanide-free scrub solution, wherein the lanthanide-free scrub solution is recycled to the contacting step (d).

The processes and methods may further include contacting the lanthanide scrub liquor with a precipitation agent to form transition metal solids and a scrub solution; and contacting the scrub solution with a lanthanide extractant to form a lanthanide free-scrub solution and a lanthanide-loaded organic stream, wherein the lanthanide-free scrub solution is recycled to the contacting step (d).

The processes and methods may further include contacting the transition metal-rich solution with a precipitation agent to form transition metal solids and a second transition metal stripping solution, wherein the second transition metal stripping solution is recycled to step (b).

The precipitation agent may be an alkali neutralization compound which generates the alkali compound used in the scrubbing and/or stripping solutions as a result of the precipitation reaction. The precipitation agent may be an alkali compound comprising sodium, potassium, magnesium, calcium, strontium or ammonium. The precipitation agent may be a carbonate, an oxide, a hydroxide, or an oxychloride.

The DGA extractant may comprise one or more DGA compounds, and wherein the one or more DGA compounds comprise di-methyl di-octyl diglycolamide (DMDODGA), and di-methyloctyl dihexyl diglycolamide (DMODHDGA).

The one or more lanthanides may comprise scandium, yttrium, lanthanum, cerium, praseodymium, neodymium, samarium, europium, gadolinium, terbium, dysprosium, holmium, erbium, thulium, ytterbium, and lutetium.

The transition metals may comprise iron (Fe), titanium (Ti), niobium (Nb), vanadium (V), chromium (Cr), cobalt (Co), nickel (Ni), zirconium (Zr), aluminum (Al), or combinations thereof.

The first and/or second alkali compounds may comprise alkali metals, alkaline earth metals, and ammonium compounds.

In some embodiments, the recovery processes and methods can include the steps of:
a) phase-separating a lanthanide-and transition metal-containing solution into a raffinate and a loaded organic comprising at least most of the lanthanides and transition metal in the lanthanide-and transition metal-containing solution, the phase-separating comprising contacting the lanthanide-and transition metal-containing solution with a diglycoamide (DGA) extractant;
b) scrubbing at least a portion of the transition metals from the loaded organic to form a transition metal-rich solution comprising at least most of the transition metal in the loaded organic and a transition metal scrubbed organic comprising at least most of the lanthanides in the loaded organic; and
c) scrubbing at least most of the lanthanides from the transition metal scrubbed organic to form a lanthanide-rich liquor comprising dissolved lanthanides.

The processes and methods may further include:
d) phase-separating, prior to step (a), a pregnant leach solution into the lanthanide—and transition metal—containing solution and a second loaded organic based at least in part on contacting the pregnant leach solution with a tributyl phosphate (TBP) extractant.

The processes and methods may further include recovering at least a portion of remaining lanthanides from the second loaded organic to form a second lanthanide—comprising solution, wherein the lanthanide—comprising solution is directed to the phase separating step (a).

The processes and methods may further include recovering at least a portion of the transition metals in the second loaded organic to form a scrubbed organic and a transition metal liquor.

The scrubbed organic may be recycled to the phase-separating step (d). The processes and methods may further include:
d) contacting, prior to the scrubbing step (c), the transition metal scrubbed organic and a lanthanide scrubbing solution to form a lanthanide scrub liquor and a lanthanide scrubbed organic.

The processes and methods may further include contacting the lanthanide scrub liquor with a precipitation agent to form transition metal solids and a lanthanide-free scrub solution, wherein the lanthanide-free scrub solution is recycled to the contacting step (d).

The processes and methods may further include contacting the lanthanide scrub liquor with a precipitation agent to form transition metals solids and a scrub solution; and contacting the scrub solution with a lanthanide extractant to form a lanthanide free-scrub solution and a lanthanide-loaded organic stream, wherein the lanthanide-free scrub solution is recycled to the contacting step (d).

The processes and methods may further include contacting the transition metal-rich solution with a precipitation agent to form transition metal solids and a transition metal stripping solution, wherein the transition metal stripping solution is recycled to step (b).

The scrubbing step (b) may comprise contacting the loaded organic with a first alkali compound and wherein the scrubbing step (c) comprises contacting the transition metal scrubbed organic with a second alkali compound.

The first and/or second alkali compounds may be in the form of a salt, and wherein the salt is a chloride or a nitrate salt such as magnesium chloride, calcium chloride, strontium chloride, ammonium chloride, sodium chloride, magnesium nitrate, calcium nitrate, strontium nitrate, ammonium nitrate, sodium nitrate, or combinations thereof. The first and second alkali compound may be the same or different.

The first and/or second alkali compounds may comprise sodium, potassium, magnesium, calcium, strontium or ammonium. The first and/or second alkali compounds may comprise alkali metals, alkaline earth metals, and ammonium compounds.

The scrubbing step (b) may scrub at least about 15% of the transition metals from the loaded organic, and wherein at least most of the lanthanides are maintained in the loaded organic after the scrubbing step (b).

The scrubbing step (b) may scrub at least about 5% of lanthanum and cerium metals from the loaded organic, and wherein at least most of the remaining lanthanides are maintained in the loaded organic after the scrubbing step (b).

The scrubbing step (c) may scrub at least about 35% of the lanthanides from the transition metal scrubbed organic.

The lanthanide-and transition metal-containing solution may comprise actinides, wherein the loaded organic comprises at least most of the actinides, wherein at least some of the actinides are removed from the loaded organic in the scrubbing step (b), and wherein at least most of the lanthanides are maintained in the loaded organic after the scrubbing step (b).

The scrubbing step (b) may scrub at least about 15% of the actinides from the loaded organic.

The actinides comprise actinium (Ac), thorium (Th), protactinium (Pa), uranium (U), neptunium (Np), plutonium (Pu), americium (Am), or combinations thereof.

The scrubbing step (b) may selectively scrub at least a portion of the transition metals, lanthanum, cerium, thorium, actinides, or a combination thereof from the loaded organic, and wherein at least most of the yttrium, terbium, europium, thulium, ytterbium, praseodymium, dysprosium, gadolinium, lutetium, promethium, scandium, neodymium, samarium, erbium, and holmium of the lanthanides are maintained in the loaded organic after the scrubbing step (b).

The DGA extractant may comprise one or more DGA compounds, and wherein the one or more DGA compounds comprise di-methyl di-octyl diglycolamide (DMDODGA), and di-methyloctyl dihexyl diglycolamide (DMODHDGA).

The one or more lanthanides may comprise scandium, yttrium, lanthanum, cerium, praseodymium, neodymium, samarium, europium, gadolinium, terbium, dysprosium, holmium, erbium, thulium, ytterbium, and lutetium.

The transition metals may comprise iron (Fe), titanium (Ti), niobium (Nb), vanadium (V), chromium (Cr), cobalt (Co), nickel (Ni), zirconium (Zr), aluminum (Al), or combinations thereof.

In some embodiments, the recovery processes and methods can include the steps of:
a) phase-separating a pregnant leach solution into a lanthanide-rich raffinate and a first loaded organic based at least in part on contacting the pregnant leach solution with a tributyl phosphate (TBP) extractant;
b) contacting the lanthanide-rich raffinate with a diglycoamide (DGA) extractant to form a second raffinate and a second loaded organic comprising at least most of the lanthanides in the lanthanide-rich raffinate and one or more transition metals;
c) removing at least a portion of the one or more transition metals from the second loaded organic to form a transition metal-rich solution and a transition metal scrubbed organic comprising at least most of the lanthanides; and
d) removing at least a portion of the lanthanides from the transition metal scrubbed organic to form a lanthanide liquor comprising dissolved lanthanides.

The processes and methods may further include removing at least a portion of the lanthanides from the first loaded organic to form a lanthanide stripped organic and a lanthanide-rich solution based at least in part on contacting the first loaded organic with a lanthanide stripping solution.

The processes and methods may further include contacting the lanthanide-rich solution with the DGA extractant to form the second raffinate and the second loaded organic.

The lanthanide stripping solution may comprise hydrochloric acid.

The processes and methods may further include:
e) removing at least a portion of the transition metals from the lanthanide stripped organic based at least in part on contacting the lanthanide stripped organic with a transition metal stripping solution and forming a stripped organic and a transition metal liquor.

The processes and methods may further include recycling the stripped organic to the phase-separating step (a).

The transition metals removed by the transition metal stripping solution in step (e) may consist of iron. The transition metals removed by the transition metal stripping solution in step € may comprise of iron.

The transition metals stripping solution may comprise hydrochloric acid and ferric chloride.

The pregnant leach solution, the first loaded organic, the second loaded organic, or a combination thereof may comprise one or more lanthanides, transition metals, or combinations thereof.

The removing step (c) may comprise contacting the second loaded organic with a first alkali compound and wherein the removing step (d) comprises contacting the transition metal scrubbed organic with a second alkali compound.

The first and/or second alkali compounds may be in the form of a salt, and wherein the salt is a chloride or a nitrate salt such as magnesium chloride, calcium chloride, strontium chloride, ammonium chloride, sodium chloride, magnesium nitrate, calcium nitrate, strontium nitrate, ammonium nitrate, sodium nitrate, or combinations thereof.

The first and second alkali compound may be the same or different. The first and/or second alkali compounds may comprise sodium, potassium, magnesium, calcium, strontium or ammonium. The first and/or second alkali compounds may comprise alkali metals, alkaline earth metals, and ammonium compounds.

The removing (c) may scrub at least about 15% of the transition metals from the second loaded organic, and wherein at least most of the lanthanides are maintained in the second loaded organic after the removing step (c).

The removing step (c) may scrub at least about 5% of the lanthanum and cerium metals from the second loaded organic, and wherein at least most of the remaining lanthanides are maintained in the second loaded organic after the removing step (c).

The removing step (d) may scrub at least about 35% of the lanthanides from the transition metal scrubbed organic.

The pregnant leach solution may comprise rare earth elements comprising at least the lanthanides, and wherein at least most of the rare earth elements are recovered from the pregnant leach solution.

The DGA extractant may comprise one or more DGA compounds, and wherein the one or more DGA compounds comprise di-methyl di-octyl diglycolamide (DMDODGA), and di-methyloctyl dihexyl diglycolamide (DMODHDGA).

The one or more lanthanides may comprise scandium, yttrium, lanthanum, cerium, praseodymium, neodymium, samarium, europium, gadolinium, terbium, dysprosium, holmium, erbium, thulium, ytterbium, and lutetium.

The transition metals may comprise iron (Fe), titanium (Ti), niobium (Nb), vanadium (V), chromium (Cr), cobalt (Co), nickel (Ni), zirconium (Zr), aluminum (Al), or combinations thereof.

The pregnant leach solution, the raffinate, and the second loaded organic may comprise actinides, and wherein at least some of the actinides are removed from the second loaded organic in the removing step (c), and wherein at least most of the lanthanides are maintained in the second loaded organic after the removing step (c).

The removing step (c) may scrub at least about 15% of the actinides from the second loaded organic. The actinides may comprise actinium (Ac), thorium (Th), protactinium (Pa), uranium (U), neptunium (Np), plutonium (Pu), americium (Am), or combinations thereof.

The removing step (c) may selectively scrub at least a portion of the transition metals, lanthanum, cerium, thorium, actinides, or a combination thereof from the second loaded organic, and wherein at least most of the yttrium, terbium, europium, thulium, ytterbium, praseodymium, dysprosium, gadolinium, lutetium, promethium, scandium, neodymium, samarium, erbium, and holmium of the lanthanides are maintained in the second loaded organic after the removing step (c).

The present disclosure can provide a number of advantages depending on the particular configuration. For example, the system and method of the present disclosure can effectively and selectively recover valuable rare earth elements (e.g., yttrium, terbium, europium, thulium, ytterbium, praseodymium, dysprosium, gadolinium, lutetium, promethium, scandium, neodymium, samarium, erbium, and holmium), in the presence of other compounds such as iron and magnesium, and/or can strip rare earth elements without being limited to low ionic strength solutions or prestripitation.

These and other advantages will be apparent from the disclosure contained herein.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

“Absorption” is the incorporation of a substance in one state into another of a different state (e.g. liquids being absorbed by a solid or gases being absorbed by a liquid). Absorption is a physical or chemical phenomenon or a process in which atoms, molecules, or ions enter some bulk phase—gas, liquid or solid material. This is a different process from adsorption, since molecules undergoing absorption are taken up by the volume, not by the surface (as in the case for adsorption).

“Adsorption” is the adhesion of atoms, ions, biomolecules, or molecules of gas, liquid, or dissolved solids to a surface. This process creates a film of the adsorbate (the molecules or atoms being accumulated) on the surface of the adsorbent. It differs from absorption, in which a fluid permeates or is dissolved by a liquid or solid. Similar to surface tension, adsorption is generally a consequence of surface energy. The exact nature of the bonding depends on the details of the species involved, but the adsorption process is generally classified as physisorption (characteristic of weak van der Waals forces)) or chemisorption (characteristic of covalent bonding). It may also occur due to electrostatic attraction.

A “rare earth elements” or “REEs” or “rare earth metals” or (in context) “rare-earth oxides”, or the “lanthanides” comprise the 15 metallic chemical elements with atomic numbers 57-71, from lanthanum through lutetium, along with the chemically similar elements scandium and yttrium. Particularly, the term “rare earth elements” or the like comprises yttrium, terbium, europium, thulium, ytterbium, praseodymium, dysprosium, gadolinium, lutetium, promethium, scandium, neodymium, samarium, erbium, and holmium. The terms lanthanides and REEs, or the like, may be used interchangeably herein and should be understood to

The term “lanthanides (Ln)” referred to herein comprises the following elements and their compounds: scandium (Sc), yttrium (Y), lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb) and lutetium (Lu).

The terms “lanthanides” and “REEs”, or the like, may be used interchangeably herein and should be understood to include scandium (Sc), yttrium (Y), lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb) and lutetium (Lu).

The term “diglycoamide extractant (DGA)” comprises DMDODGA, DMODHDGA (DG6), tetraoctyl diglycolamide (TODGA), tetra (2 Ethylhexyl) diglycolamide (TEHDGA), among others. The DGA extractant used herein may include one or a mixture of any number of DGA compounds.

The term “transition metals” comprises any metals which constitutes an impurity in the target product, including but not limited to iron, copper, lead, nickel, zinc, cobalt, aluminum, tin, titanium, zirconium, antimony, manganese, chromium, germanium, vanadium, gallium, hafnium, indium, niobium, rhenium, thallium, and thorium.

The term “transition metals” comprises iron, copper, lead, nickel, zinc, cobalt, aluminum, tin, titanium, zirconium, antimony, manganese, chromium, germanium, vanadium, gallium, hafnium, indium, niobium, rhenium, thallium, and thorium. Particularly, the term “transition metals” comprises iron, aluminum, nickel, copper, cobalt, chromium, titanium, zirconium, vanadium, niobium and in some embodiments, zinc. Still more particularly, the term “transition metals” comprises iron, aluminum, nickel, copper, cobalt, chromium, and in some embodiments, zinc. Still more particularly, the term “transition metals” comprises iron and aluminum. Still more particularly, the term “transition metals” comprises iron. The terms “transition metal” and “base metal” may be used interchangeably throughout the present disclosure.

The term “actinides” refers to any one or more of the fifteen metallic chemical elements with atomic numbers from 89 to 103, including actinium (Ac), thorium (Th), protactinium (Pa), uranium (U), neptunium (Np), plutonium (Pu), and americium (Am).

The term “alkali compound” comprises alkali metals of Group 1A of the periodic table (e.g., hydrogen (H), lithium (Li), sodium (Na), potassium (K), rubidium (Rb), cesium (Cs), and francium (Fr)), alkaline earth metals of Group 2A of the periodic table (e.g., beryllium (Be), magnesium (Mg), calcium (Ca), strontium (Sr), barium (Ba), and radium (Ra)), and ammonium compounds.

A “mineral acid” is an inorganic acid, such as sulfuric acid, nitric acid, or hydrochloric acid.

A “salt” is an ionic compound that results from the neutralization reaction of an acid and a base. Salts are composed of cations (positively charged ions) and anions (negative ions) so that the product is electrically neutral (without a net charge). These component ions can be inorganic such as chloride (Cl⁻), as well as organic such as acetate (CH₃COO⁻) and monatomic ions such as fluoride (F⁻), as well as polyatomic ions such as sulfate (SO₄²⁻). Salts that hydrolyze to produce hydroxide ions when dissolved in water are basic salts and salts that hydrolyze to produce hydronium ions in water are acid salts. Neutral salts are those that are neither acid nor basic salts. The term “salt” and “metal salt” may be used interchangeably herein.

A “pregnant leach solution” or “PLS” refers to an acidic metal-laden water generated from leaching (e.g., stockpile leaching, heap leaching, agitated tank leaching).

“Sorb” means to take up a liquid or a gas either by sorption.

“Sorption” refers to adsorption and absorption, while desorption is the reverse of adsorption.

The term “prestripitation” refers to a process involving the simultaneous (or near simultaneous) stripping and precipitation of a compound from an organic phase.

The terms “stripped”, “strip”, and “stripping” may refer to the complete (e.g., near or equal to about 100%) removal of a target compound from a solution, whereas “scrubbed”, “scrub”, and “scrubbing” may refer to the partial removal (e.g., less than about 100%, less than about 90%, less than about 80%, less than about 70%, less than about 60%, less than about 50%, less than about 40%, less than about 30%, less than about 20%, less than about 10%) of a target compound from a solution. Although, it should be understood that “strip” (and variation of the same), and “scrub” (and variation of the same) may be used herein interchangeably.

It should be understood that while pH is a measure for acid concentration, typically, pH is used for acid concentration between 0.1 (pH=1) and 10⁻¹⁴ (pH=14) mol per liter (mol/L) acid. Therefore, it does not make sense for acidity greater than 1 M/L because the value becomes negative. Therefore, concentrations of acids are used herein in place of pH.

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

The preceding is a simplified summary of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The accompanying drawings are incorporated into and forms a part of the specification to illustrate several examples of the present disclosure. These drawings, together with the description, explains the principles of the disclosure. The drawings simply illustrate preferred and alternative examples of how the disclosure can be made and used and is not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a process flow schematic utilizing a diglycoamide extractant (DGA) according to an embodiment of the disclosure;

FIG. 2 is a process flow schematic utilizing a DGA extractant according to an embodiment of the disclosure;

FIG. 3 is a process flow schematic utilizing a DGA extractant according to an embodiment of the disclosure;

FIG. 4 is a process flow schematic utilizing a DGA extractant according to an embodiment of the disclosure;

FIG. 5 is a process flow schematic utilizing a tributyl phosphate (TBP) extractant according to an embodiment of the disclosure;

FIG. 6 is a process flow schematic utilizing one or more DGA extractants and/or one or more TBP extractants according to an embodiment of the disclosure; and

FIG. 7 is a process flow schematic utilizing one or more DGA extractants and/or one or more TBP extractants according to an embodiment of the disclosure.

FIGS. 8A, 8B, 8C, and 8D depict plots of various compound concentrations (vertical axis) in various TBP circuit streams against days of operation (horizontal axis) according to embodiments of the disclosure.

FIGS. 9A, 9B, 9C, 9D and 9E depict plots of various compound concentrations (vertical axis) in various DGA circuit streams against days of operation (horizontal axis) according to embodiments of the disclosure.

FIGS. 10A and 10B depict plots of recoveries distribution (vertical axis) to various circuit streams for various impurities (horizontal axis) according to embodiments of the disclosure.

FIG. 11A depicts a process flow schematic utilizing a DGA extractant according to an embodiment of the disclosure.

FIG. 11B depicts a plot of extraction and stripping extents of various elements throughout the process flow depicted in FIG. 11A, according to an embodiment of the disclosure.

FIG. 12 depicts a plot of extraction extents of various elements for multiple extractions according to embodiments of the disclosure with the PLS composition for those elements.

FIG. 13 depicts a plot of various elements in a strip liquor for various strip solution compositions according to embodiments of the disclosure.

### DETAILED DESCRIPTION

Unless defined otherwise, all technical and scientific terms used herein have the same meaning as is commonly understood by one of ordinary skill in the art. All patents, applications, published applications, and other publications to which reference is made herein are incorporated by reference in their entirety. If there is a plurality of definitions for a term herein, the definition provided in the Summary prevails unless otherwise stated.

The present disclosure provides processes for recovering lanthanides (i.e., rare earth elements and scandium) from acidic solutions. The processes and methods of the present disclosure use diglycoamide extractants (DGA), a class of organic extractant, for the selective bulk extraction of lanthanide(s) (Ln), such as from a pregnant leach solution. The bulk extraction of the lanthanides may be achieved by the selective removal of non-lanthanide compounds from a feed solution by one or more scrubbing, stripping, extraction, and/or precipitation units. Non-limiting examples of a DGA compound comprises dimethyl, di-octyl diglycolamide (DMDODGA) and di-methyloctyl dihexyl diglycolamide (DMODHDGA, DG6). DMDODGA typically has a higher affinity for REEs than DG6. Surprisingly and unexpectedly, DG6 may be the preferred extractant as DMDODGA may bind so strongly to the REEs and other elements that a third phase rich in metals is created, preventing the stable operation of the circuit in high organic metal loading scenarios. It is important that the extractant (e.g., DGA, DG6, DMDODGA) is at least mostly or fully miscible with the aqueous to be an effective extractant. In other embodiments, DMDODGA may be the preferred DGA extractant. In some embodiments, the preferred DGA extract may comprise a combination of two or more DGA compounds.

A DGA circuit of the present disclosure may comprise one or more extraction units [A] wherein lanthanides and other metals are extracted to an organic phase from an acid (feed) solution (e.g., a pregnant leach solution (PLS), some other lanthanide-comprising acidic stream). The acidic phases of the present disclosure including the feed solutions, scrub solutions, and strip solutions can be an aqueous phase, a polar molecular non-aqueous phase or an ionic liquid phase. Acids included in the acidic phases can include but are not limited to one of, or a combination of the following inorganic acids (i.e., mineral acid): hydrochloric acid, nitric acid, sulfuric acid, phosphoric acid and/or organic acids such as acetic acid, citric acid or lactic acid. The organic phase can be an organic phase or an ionic liquid phase and may comprise one or more DGA compounds, and a combination of modifiers and diluents.

In an embodiment of the present disclosure, the DGA circuit utilizes DMDODGA with a concentration in the range of about 0.5 to 100 volume % (vol.%), preferably in the range of about 0-50 vol. %, or more preferably in the range of about 0-40 vol. %, or more preferably in the range of about 0-30 vol. %, or more preferably in the range of about 0-20 vol. %, or more preferably in the range of about 0-10 vol. %, and even more preferably in the range of about 1-8 vol. %. In an embodiment of the present disclosure, the DGA circuit utilizes DG6 with a concentration in the range of about 0.5 to 100 vol. %, preferably in the range of about 0-60 vol. %, or more preferably in the range of about 0-50 vol. %, or more preferably in the range of about 0-40 vol. %, or more preferably in the range of about 5-30 vol. %., and even more preferably in the range of about 10-25 vol. %. Modifiers may include one or a mixture of alcohols and ethers.

In an embodiment of the present disclosure, the modifier(s) included in the DGA extractant comprise 2-Ethyl-Hexanol, or other long chain and/or branched alcohols that are liquid under operating procedures (e.g., c7-OH to c16-OH), wherein the concentration of the modifier(s) in the DGA extractant is in the range of about 0 to 99.5 vol. %, or more preferably in the range of about 0-60 vol. %., or more preferably in the range of about 10-50 vol. %., and even more preferably in the range of about 20-40 vol. %. In an embodiment of the present disclosure, the modifiers comprise long chain alcohols such as alcohols with 11 to 13 carbons with a concentration in the range of about 0 to 99.5 vol. %, or more preferably in the range of about 0-70 vol. %, or more preferably in the range of about 5-60 vol. %, or more preferably in the range of about 10-50 vol. %, and even more preferably in the range of about 15-40 vol. %.

In an embodiment of the present disclosure, the diluent(s) included in the DGA extractant comprise one or a mixture of aliphatic or aromatic hydrocarbons or one or a mixture of ionic liquids. In an embodiment of the present disclosure, the diluent comprises kerosene, hexane, heptane, octane, decane, any other liquid hydrocarbons, any other aliphatic straight chain hydrocarbons, and/or any other aromatic organic solution(s) (e.g., xylene, benzene, toluene). The diluent(s) may have a concentration in the DGA extract in the range of about 0 to 99.5 vol. %, or more preferably in the range of about 10-90 vol. %, or more preferably in the range of about 20-80 vol. %, or more preferably in the range of about 30-70 vol. %, and even more preferably in the range 40-60 vol. %.

One or more transition metal stripping units [B] may be included in the DGA circuit, wherein non-lanthanide (transition) metals (e.g., iron (Fe)) are stripped from the organic phase into a metal strip solution (e.g., an iron strip solution). The stripped (transition) metals (e.g., iron and other metals) may be precipitated in one or more transition metal precipitation units [C] and may then be removed from the DGA circuit. In some embodiments, the organic phase may proceed to one or more lanthanide scrub units [D], wherein all or a majority of non-lanthanide (transition) metals are stripped from the organic phase into a scrub solution. In some embodiments, a portion (typically no more than about 25%) of the lanthanides in the organic phase may also be stripped into the scrub solution. The organic phase may then be directed to one or more lanthanide stripping units [E], wherein all or a majority of the lanthanide is stripped from the organic phase into a lanthanide strip solution. The DGA circuit may include one or more lanthanide scrub precipitation units [F], wherein iron and/or other transition metals may be selectively precipitated from the lanthanide scrub solution and removed from the DGA circuit with minimal losses (e.g., typically no more than about 25% and more typically no more than about 10%) of lanthanide. Stated differently, typically at least most, more typically about 65%, more typically at least about 75%, and even more typically at least about 85% of a selected transition metal are precipitated from the lanthanide scrub solution and removed from the DGA circuit. The lanthanide scrub solution may proceed to one or more lanthanide scrub extraction units [G] in which the lanthanide(s) are extracted from the lanthanide scrub solution and may be sent to another circuit for further processing.

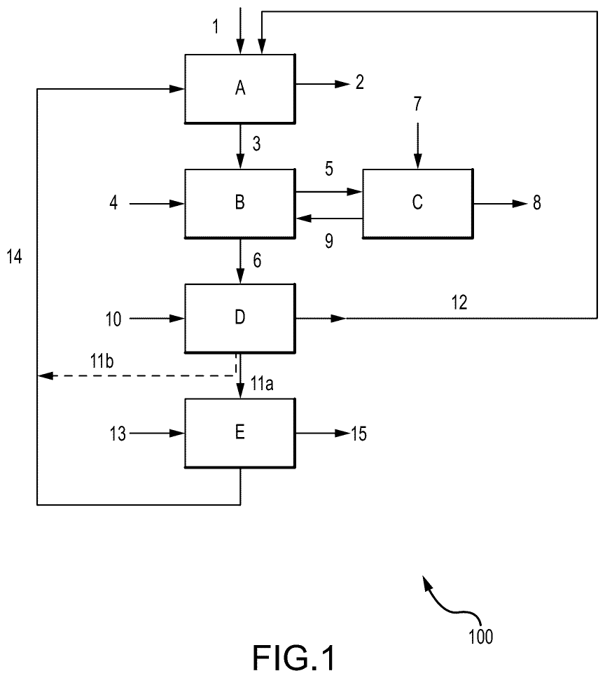

Embodiments of DGA circuits are described in further detail with reference to FIGS. 1 to 4. Although, it should be understood that the DGA circuits described with reference to FIGS. 1 to 4 are provided as examples and a DGA circuit of the present disclosure may include all or a portion of units [A] to [G] arranged in any combination, a DGA circuit of the present disclosure may include multiples of one or more of units [A] to [G], and/or may include additional units not depicted and/or defined by units [A] to [G]. It should be understood that a DGA circuit of the present disclosure is not limited to the examples provided herein.

FIG. 1 illustrates a process flow schematic 100 utilizing a DGA according to an embodiment of the disclosure. The process flow schematic 100 includes an extraction unit [A], a transition metals stripping unit [B], a transition metal precipitation unit [C], a lanthanide scrub unit [D], and a lanthanide stripping unit [E].

In the process flow schematic 100, an acidic feed solution [1] comprises typically from about 10E-06 to about 100 g/L of one or more lanthanide(s), from about 0.01 g/L to about to its saturation concentration in the acidic solution at ambient temperature and pressure of one or more mineral acids, and from about 10E-06 to about 50 g/L of one or more transition metals. Typically, at least most of the transition metals in the acidic feed solution comprise iron.

The acidic feed solution [1] is contacted with a DGA extractant source in the extraction stage [A] and the resulting mixture is phase separated into a raffinate [2] and a loaded organic [3] comprising at least most and more typically at least about 75% of the transition metals (e.g., iron) and lanthanides in the feed solution [1]. The DGA extractant source may be newly added to the process flow schematic 100, and/or may be a recycled DGA extractant [14].

The raffinate [2] from the extraction stage [A] may be sent to a different portion of the process, a different circuit, etc. for further processing.

The loaded organic [3] is stripped of all or a portion (typically at least most and more typically at least about 75%) of transition metal(s) in the loaded organic [3] by the transition metal stripping unit [B] using the recycled base metal strip solution [9] and/or a makeup of transition metal strip solution [4], forming a transition metal.

The transition metal-rich solution [5] is contacted with a precipitation agent [7] causing a reaction in the transition metal precipitation unit [C] and at least most of and more typically at least about 75% of the dissolved transition metal(s) are precipitated out of the solution and separated, resulting in transition metal solids [8]. The transition metal solids [8] leave the circuit and can be further processed elsewhere. A person skilled in the art will recognize that the presence of a bleed stream in the transition metal precipitation circuit [C] is implicit to the process to control the impurity level in the recirculating loop. The transition metal stripped organic [6], which comprises at least most and more typically at least about 75% of the lanthanides in the feed solution [1], is then scrubbed of all or a portion (typically at least most and more typically at least about 75%) of any remaining transition metal, while dissolving only a portion (typically no more than about 25% and more typically no more than about 15%) of its lanthanides, using the lanthanide scrub solution

in the lanthanide scrub unit [D]. The resulting scrub liquor may be recycled to the extraction unit [A] while the scrubbed organic [11a] is sent to the lanthanide strip unit [E]. At this juncture, the scrubbed organic [11a] comprises at least about 75% and more typically at least about 85% of the lanthanides but no more than about 10% and more typically no more than about 5% of the transition metals in the feed solution [1]. In some embodiments, a fraction of the scrubbed organic [11b] (between 0 vol. % and 99.99 vol. % based on the system, contents and concentrations of the acidic feed stream, etc.) may be recycled to the extraction unit [A] to increase the lanthanide concentration in the organic phase and reduce the transition metal extraction. As rare earth elements are favored, when the scrubbed organic [11b] that comprises rare earth elements is recycled back to the extraction unit [A], the rare earth elements already loaded on the organic will outcompete some of the transition metals during the extraction. A person skilled in the art will recognize that the scrubbed organic recycle fraction can be adjusted with consideration of the concentration of lanthanide in the acidic feed solution [1]. Additionally, a person skilled in the art will recognize that a similar recycle can be included using stream [6].

Finally, the scrubbed organic [11a] is stripped of at least most and more typically at least about 95% of its lanthanide content using a lanthanide strip solution [13], resulting in the lanthanide liquor [15], which can be further processed by lanthanide separation processes.

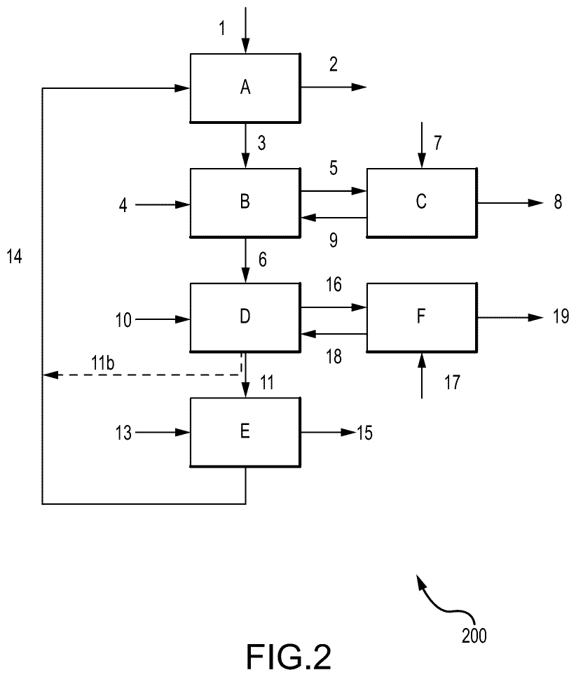

FIG. 2 illustrates a process flow schematic 200 utilizing a DGA extractant according to an embodiment of the disclosure. The process flow schematic 200 includes an extraction unit [A], a transition metals stripping unit [B], a transition metal precipitation unit [C], a lanthanide scrub unit [D], a lanthanide stripping unit [E], and a lanthanide scrub precipitation unit [F].

In the process flow schematic 200, the acidic feed solution [1] comprising

lanthanide(s) is contacted with a recycled DGA extractant in the extraction unit [A] and the resulting mixture is phase separated into a raffinate [2] and a loaded organic [3] comprising at least most and more typically at least about 75% of the transition metals (e.g., iron) and lanthanides in the feed solution [1]. The raffinate [2] from the extraction stage [A] may be sent to a different portion of the process, a different circuit, etc. for further processing.

The loaded organic [3] is stripped of all or a portion (typically at least most and more typically at least about 75%) of transition metal(s) in the loaded organic [3] by the transition metal stripping unit [B] using the recycled transition metal strip solution [9] and/or a makeup of transition metal strip solution [4].

The transition metal-rich solution [5] is contacted with a precipitation agent [7] causing a reaction in the transition metal precipitation unit [C] and at least most of and more typically at least about 75% of the dissolved transition metal(s) are precipitated out of the solution and separated, resulting in transition metal solids [8]. The transition metal solids [8] leave the circuit and can be further processed elsewhere. A person skilled in the art will recognize that the presence of a bleed stream in the transition metal precipitation unit [C] is implicit to the process to control the impurity level in the recirculating loop.

The transition metal stripped organic [6], which comprises at least most and more typically at least about 75% of the lanthanides in the feed solution [1], is then scrubbed of all or a portion (typically at least most and more typically at least about 75%) of any remaining transition metals while dissolving only a portion (typically no more than about 25% and more

typically no more than about 15%) of its lanthanides, using the lanthanide scrub solution and recycled lanthanide scrub solution in the lanthanide scrub unit [D]. The resulting

scrub liquor is contacted with a precipitation agent in the lanthanide scrub precipitation unit [F] causing a reaction, and the transition metal(s) are precipitated out of the

solution and separated, resulting in transition metal solids [19]. The transition metal solids

leave the circuit and can be further processed elsewhere. A person skilled in the art will recognize that the presence of a bleed stream in the lanthanide scrub precipitation unit [F] is implicit to the process to control the impurity level in the recirculating loop. The resulting scrub solution is recycled to the lanthanide scrub unit [D].

The scrubbed organic is sent to the lanthanide strip unit [E]. At this juncture, the scrubbed organic [11a] comprises at least about 75% and more typically at least about 85% of the lanthanides but no more than about 10% and more typically no more than about 5% of the transition metals in the feed solution [1] In some embodiments, a fraction of the scrubbed organic [11b] (between 0 vol. % and 99.99 vol. %) may be recycled to the extraction unit [A] to increase the lanthanide concentration in the organic and reduce the transition metal extraction. A person skilled in the art will recognize that the scrubbed organic recycle fraction will be adjusted with consideration of the concentration of lanthanide in the acidic feed solution [1]. Additionally, a person skilled in the art will recognize that a similar recycle can be included using stream [6].

Finally, the scrubbed organic is stripped of at least most and more typically at least about 95% of its lanthanide content using the lanthanide strip solution [13], resulting in the lanthanide liquor which can be further processed by lanthanide separation processes.

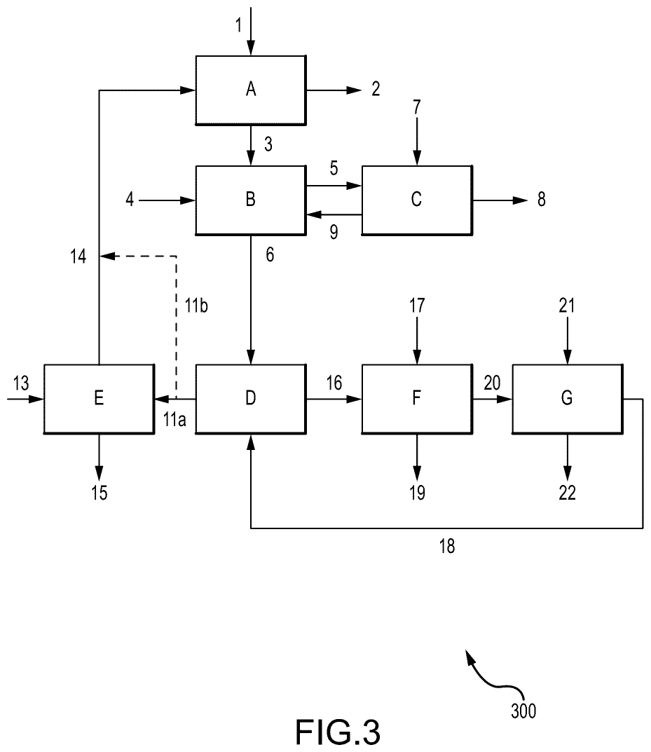

FIG. 3 illustrates a process flow schematic 300 utilizing a DGA extractant according to an embodiment of the disclosure. The process flow schematic 300 includes an extraction unit [A], a transition metals stripping unit [B], a transition metal precipitation unit [C], a lanthanide scrub unit [D], a lanthanide stripping unit [E], a lanthanide scrub precipitation unit [F], and a lanthanide scrub extraction unit [G].

In the process flow schematic 300, the acidic feed solution [1] comprising lanthanide(s) is contacted with a recycled DGA extractant in the extraction unit [A] and the resulting mixture is phase separated into a raffinate [2] and a loaded organic [3] comprising at least most and more typically at least about 75% of the transition metals (e.g., iron) and lanthanides in the feed solution [1]. The raffinate [2] from the extraction stage [A] may be sent to a different portion of the process, a different circuit, etc. for further processing.

The loaded organic [3] is stripped of all or a portion (typically at least most and more typically at least about 75%) of transition metal(s) in the loaded organic [3] by the transition metal stripping unit [B] using the recycled transition metal strip solution [9] and/or a makeup of transition metal strip solution [4].

The transition metal-rich solution [5] is contacted with a precipitation agent [7] causing a reaction in the transition metal precipitation unit [C] and at least most of and more typically at least about 75% of the dissolved transition metal(s) are precipitated out of the solution and separated, resulting in transition metal solids [8]. transition metal solids [8] leave the circuit and can be further processed elsewhere. A person skilled in the art will recognize that the presence of a bleed stream in the transition metal precipitation unit [C] is implicit to the process to control the impurity level in the recirculating loop.

The transition metal stripped organic [6], which comprises at least most and more typically at least about 75% of the lanthanides in the feed solution [1], is then scrubbed of all or a portion (typically at least most and more typically at least about 75%) of any remaining transition metals while dissolving only a portion (typically no more than about 25% and more typically no more than about 15%) of its lanthanide using the lanthanide scrub solution makeup (not shown) and/or recycled lanthanide scrub solution in the lanthanide scrub Unit [D]. The resulting scrub liquor is reacted with a precipitation agent in the lanthanide Scrub Precipitation unit [F] and at least most of the transition metals are precipitated out of the solution and separated. The transition metal solids leave the circuit and can be further processed elsewhere. A person skilled in the art will recognize that the presence of a bleed stream in the lanthanide Scrub Precipitation Circuit [F] is implicit to the process to control the impurity level in the recirculating loop.

The resulting scrub solution is contacted with a lanthanide extractant in the lanthanide extraction unit [G] to recover at least most of any lanthanide present in the scrub solution [20]. The recovered lanthanide is output from the lanthanide extraction unit [G] as a lanthanide-loaded organic stream [22], which can be further processed by known lanthanide separation processes. The resulting lanthanide-free scrub solution is recycled to the lanthanide scrub unit [D].

The scrubbed organic [11a] is sent to the lanthanide strip unit [E]. At this juncture, the scrubbed organic [11a] comprises at least about 75% and more typically at least about 85% of the lanthanides but no more than about 10% and more typically no more than about 5% of the transition metals in the feed solution [1]. In some embodiments, a fraction of the scrubbed organic [11b] (between 0 vol. % and 99.99 vol. %) may be recycled to the extraction unit [A] to increase the lanthanide concentration in the organic and reduce the transition metal extraction. A person skilled in the art will recognize that the scrubbed organic recycle fraction will be adjusted with consideration of the concentration of lanthanide in the acidic feed solution [1]. Additionally, a person skilled in the art will recognize that a similar recycle can be included using stream [6]

The Scrubbed Organic [11a] is then stripped of its lanthanide using the lanthanide strip solution [13], resulting in the lanthanide liquor [15], which can be further processed by lanthanide separation processes.

Finally, a person skilled in the art will recognize that the proposed configuration implies that all lanthanides can be stripped and recovered in the lanthanide scrub unit [D], allowing for the removal of the lanthanide strip unit [E] from the design. Alternatively, a primary separation can be undertaken between specific lanthanide in those circuit. An example among many of such separation would involve only lanthanum (La), cerium (Ce), Praseodymium (Pr), and Neodymium (Nd) being recovered in the lanthanide scrub circuit [D] and all other lanthanides being stripped in the lanthanide strip unit [E].

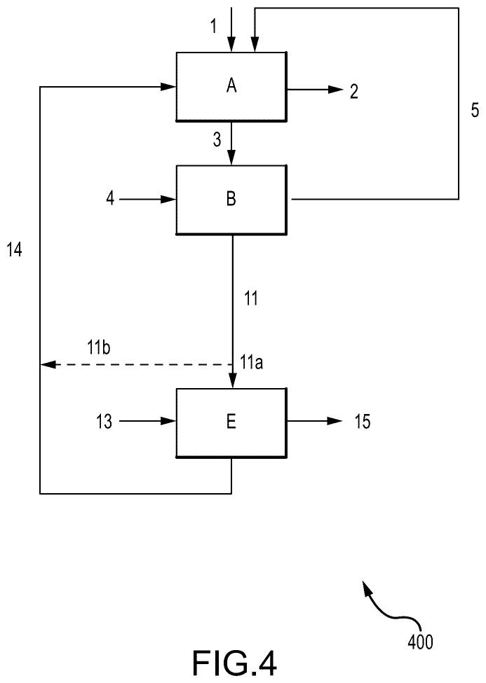

FIG. 4 illustrates a process flow schematic 400 utilizing a DGA extractant according to an embodiment of the disclosure. The process flow schematic 400 includes an extraction unit [A], a transition metals stripping unit [B], and a lanthanide stripping unit [E]. In the process flow schematic 400, the acidic feed solution [1] containing lanthanide

is contacted with a recycled DGA extractant and the transition metal Strip Solution [5] in the extraction stage [A] and the resulting mixture is phase separated into a raffinate [2] and a loaded organic [3] comprising at least most and more typically at least about 75% of the transition metals (e.g., iron) and lanthanides in the feed solution [1]. The raffinate [2] from the extraction stage [A] may be sent to a different portion of the process, a different circuit, etc. for further processing.

The loaded organic [3] is stripped of all or a portion (typically at least most and more typically at least about 75%) of transition metal content in the loaded organic [3] by the transition metal stripping unit [B] using the transition metal strip solution [4]. The transition metal strip solution [5] may be recycled to the extraction unit [A].

The transition metal stripped organic [11a] is sent to the lanthanide strip unit [E]. At this juncture, the scrubbed organic [11a] comprises at least about 75% and more typically at least about 85% of the lanthanides but no more than about 10% and more typically no more than about 5% of the transition metals in the feed solution [1]. In some embodiments, a fraction of the scrubbed organic [11b] (between 0 vol. % and 99.99 vol. %) may be recycled to the extraction unit [A] to increase the lanthanide concentration in the organic and reduce the transition metal extraction. A person skilled in the art will recognize that the scrubbed organic recycle fraction will be adjusted with consideration of the concentration of lanthanide in the feed acidic solution [1]. Additionally, a person skilled in the art will recognize that a similar recycle can be included using stream [11].

Finally, the scrubbed organic [11a] is stripped of at least most and more typically at least about 75% of its lanthanide using the lanthanide strip solution [13], resulting in the lanthanide liquor [15], which can be further processed by lanthanide separation processes.

In one non-limiting embodiment, the acidic feed solution [1], described in any of FIGS. 1 to 4, may comprise high, little or no iron (less than about 35,000 mg/L, less than about 500 mg/L, less than about 10 mg/L, less than about 1 mg/L), lanthanum (in the range of about 0 to 1500 mg/L, or 50 to 100 mg/L), cerium (in the range of about 0 to 1,500 mg/L, or 50 to 100 mg/L), praseodymium (in the range of about 0 to 1,500 mg/L, or 10 to 50 mg/L), samarium (in the range of about 0 to 1,500 mg/L, or 2 to 50 mg/L), europium (in the range of about 0 to 1,500 mg/L, or 0.1 to 200 mg/L), gadolinium (in the range of about 0 to 1,500 mg/L, or 10 to 50 mg/L), yttrium (in the range of about 0 to 1,500 mg/L, or 10 to 50 mg/L) and at least neodymium (in the range of about 0 to 1500 mg/L, or 20 to 100 mg/L), terbium (in the range of about 0 to 1,500 mg/L, or 0.1 to 10 mg/L), dysprosium (in the range of about 0 to 1,500 mg/L, or 0 to 10 mg/L), scandium (in the range of about 0 to 1,500 mg/L, or 1 to 50 mg/L) or thorium (in the range of about 0 to 1,200 mg/L, or 50 to 150 mg/L).

The raffinate [2], described in any of FIGS. 1 to 4, may comprise some or no iron (less than about 25,000 mg/L, less than about 5,000 mg/L, less than about 1,000 mg/L, less than about 10 mg/L, less than about 5 mg/L, less than about 1 mg/L), lanthanum (in the range of about 0 to 1,500 mg/L, or 0 to 100 mg/L), cerium (in the range of about 0 to 1,500 mg/L, or 0 to 100 mg/L), praseodymium (in the range of about 0 to 100 mg/L, or 0 to 5 mg/L), samarium (in the range of about 0 to 50 mg/L, or 0 to 1 mg/L), europium (in the range of about 0 to 25 mg/L, or 0 to 1 mg/L), gadolinium (in the range of about 0 to 25 mg/L, or 0 to 1 mg/L), yttrium (in the range of about 0 to 15 mg/L, or 0 to 1 mg/L) and at least neodymium (in the range of about 0 to 150 mg/L, or 0 to 10 mg/L), terbium (in the range of about 0 to 15 mg/L, or 0 to 1 mg/L), dysprosium (in the range of about 0 to 20 mg/L, or 0 to 1 mg/L), scandium (in the range of about 0 to 15 mg/L, or 0 to 1 mg/L) or thorium (in the range of about 0 to 120 mg/L, or 0 to 15 mg/L).

The transition metal-rich solution [5], as described in any of FIGS. 1 to 4, may comprise iron (less than about 50,000 mg/L, less than about 25,000 mg/L, less than about 5,000 mg/L less than about 1,000 mg/L, less than about 50 mg/L, less than about 10 mg/L, less than about 1 mg/L), lanthanum (in the range of about 0 to 4,500 mg/L, or 0 to 1500 mg/L), cerium (in the range of about 0 to 4,500 mg/L, or 0 to 1500 mg/L), praseodymium (in the range of about 0 to 100 mg/L, or 0 to 5 mg/L), samarium (in the range of about 0 to 50 mg/L, or 0 to 1 mg/L), europium (in the range of about 0 to 25 mg/L, or 0 to 1 mg/L), gadolinium (in the range of about 0 to 25 mg/L, or 0 to 1 mg/L), yttrium (in the range of about 0 to 15 mg/L, or 0 to 1 mg/L) and at least neodymium (in the range of about 0 to 150 mg/L, or 0 to 10 mg/L), terbium (in the range of about 0 to 15 mg/L, or 0 to 1 mg/L), dysprosium (in the range of about 0 to 20 mg/L, or 0 to 1 mg/L), scandium (in the range of about 0 to 15 mg/L, or 0 to 1 mg/L) or thorium (in the range of about 0 to 1200 mg/L, or 0 to 150 mg/L).

The lanthanide liquor [15], as described in any of FIGS. 1 to 4, may comprise little or no iron (less than about 200 mg/L, less than about 100 mg/L, less than about 60 mg/L, less than about 20 mg/L, less than about 10 mg/L, less than about 5 mg/L), lanthanum (in the range of about 0 to 15,000 mg/L, or 50 to 1,500 mg/L, or 250 to 750 mg/L), cerium (in the range of about 0 to 15,000 mg/L, or 50 to 1,500 mg/L, or 250 to 750 mg/L), praseodymium (in the range of about 0 to 15,000 mg/L, or 50 to 1,500 mg/L, or 50 to 250 mg/L), samarium (in the range of about 0 to 15,000 mg/L, or 5 to 1,500 mg/L, or 25 to 125 mg/L), europium (in the range of about 0 to 15,000 mg/L, or 5 to 1,500 mg/L, or 5 to 75 mg/L), gadolinium (in the range of about 0 to 15,000 mg/L, or 50 to 1,500 mg/L, or 25 to 250 mg/L), yttrium (in the range of about 0 to 15,000 mg/L, or 50 to 1,500 mg/L, or 5 to 250 mg/L) and at least neodymium (in the range of about 0 to 15,000 mg/L, or 50 to 1,500 mg/L, or 50 to 750 mg/L), terbium (in the range of about 0 to 15,000 mg/L, or 50 to 1,500 mg/L, or 1 to 75 mg/L), dysprosium (in the range of about 0 to 15,000 mg/L, or 50 to 1,500 mg/L, or 1 to 75 mg/L), scandium (in the range of about 0 to 15,000 mg/L, or 50 to 1,500 mg/L, or 1 to 75 mg/L) or thorium (in the range of about 0 to 12,000 mg/L, or 5 to 250 mg/L).

The transition metals strip solution [9] and the makeup of transition metal strip solution [4], described in any of FIGS. 1 to 4, may be an acidic phase comprising an acid and a metal salt. Acids in the transition metals strip solutions can include but are not limited to one of, or a combination of the following inorganic acids: hydrochloric acid, nitric acid, sulfuric acid, phosphoric acid and/or organic acids such as acetic acid, citric acid or lactic acid. Metal salts in the transition metals strip solutions can include but are not limited to one or, or a combination of the following: sodium chloride (NaCl), magnesium chloride (MgCl₂), magnesium bromide (MgBr₂), lithium bromide (LiBr), lithium chloride (LiCl), lithium iodide (LiI), lithium nitrate (LiNO₃), calcium chloride (CaCl₂), and potassium nitrate (KNO₃). The acid concentration ranges between 0 to 100 weight % (wt.%) and the metal salt concentration ranges between 0 grams per liter (g/L) to its saturation concentration in solution. In a non-limiting embodiment, the acid of the transition metals strip solution [9] and/or [4] is hydrochloric acid and the metal salt is magnesium chloride. The acid (e.g., hydrochloric acid) concentration in the transition metals strip solution typically ranges between about 0 to 20 moles per liter (mol/L), more typically is in the range of about 0 to 15 mol/L, more typically is in the range of about 0 to 10 mol/L, more typically is in the range of about 0 to 5 mol/L, and even more typically is in the range of about 0 to 3 mol/L. Stated differently, the acid (e.g., hydrochloric acid) concentration is typically less than about 12 mol/L, more typically less than about 8 mol/L, more typically less than about 6 mol/L, even more typically less than about 3 mol/L, and even more typically less than about 1 mol/L. The metal salt (e.g., magnesium chloride) concentration in the transition metals strip solution typically ranges between about 0 moles per liter (mol/L) to its saturation point (at room temperature), or more precisely is in the range of about 0 to 6 mol/L, more typically is in the range of about 0 to 4 mol/L, and more typically is in the range of about 0 to 2 mol/L. Stated differently, the metal salt (e.g., magnesium chloride) concentration is typically less than about 6 mol/L, more typically less than about 4 mol/L, more typically less than about 3 mol/L, and even more typically less than about 2 mol/L.

The lanthanide scrub solutions and [18], as described with reference to FIGS. 1 to 4, are in an acidic phase comprising an acid and a metal salt. Acids in the lanthanide scrub solutions can include but are not limited to one of, or a combination of the following inorganic acids: hydrochloric acid, nitric acid, sulfuric acid, phosphoric acid and/or organic acids such as acetic acid, citric acid or lactic acid. Metal salts in the lanthanide scrub solutions can include but are not limited to one or, or a combination of the following: sodium chloride (NaCl), magnesium chloride (MgCl₂), magnesium bromide (MgBr₂), lithium bromide (LiBr), lithium chloride (LiCl), lithium iodide (LiI), lithium nitrate (LiNO₃), calcium chloride (CaCl₂), and potassium nitrate (KNO₃). The acid concentration ranges between 0 to 100 wt. % and the metal salt concentration ranges between 0 g/L to its saturation concentration in solution. In a non-limiting embodiment, the acid of the lanthanide scrub solutions and/or is hydrochloric acid and the metal salt is magnesium chloride. The acid (e.g., hydrochloric acid) concentration in the lanthanide scrub solutions typically ranges between about 0 to 12 mol/L, more typically is in the range of about 0 to 8 mol/L, more typically is in the range of about 0 to 6 mol/L, more typically is in the range of about 0 to 3 mol/L, and even more typically is in the range of about 0 to 1 mol/L. Stated differently, the acid (e.g., hydrochloric acid) concentration is typically less than about 12 mol/L, more typically less than about 8 mol/L, more typically less than about 6 mol/L, even more typically less than about 3 mol/L, and even more typically less than about 1 mol/L. The metal salt (e.g., magnesium chloride) concentration in the lanthanide scrub solutions typically ranges between about 0 mol/L to its saturation point (at room temperature), or more precisely is in the range of about 0 to 6 mol/L, more typically is in the range of about 0 to 3 mol/L, and more typically is in the range of about 0 to 1 mol/L. Stated differently, the metal salt (e.g., magnesium chloride) concentration is typically less than about 6 mol/L, more typically less than about 4 mol/L, more typically less than about 3 mol/L, and even more typically less than about 2 mol/L, and even more typically less than about 1 mol/L.

The lanthanide strip solution [13], described in any of FIGS. 1 to 4, may be an acidic phase comprising an acid and a metal salt. Acids in the lanthanide strip solution can include but are not limited to one of, or a combination of the following inorganic acids: hydrochloric acid, nitric acid, sulfuric acid, phosphoric acid and/or organic acids such as acetic acid, citric acid or lactic acid. Metal salts in the lanthanide strip solution can include but are not limited to one or, or a combination of the following: sodium chloride (NaCl), magnesium chloride (MgCl₂), magnesium bromide (MgBr₂), lithium bromide (LiBr), lithium chloride (LiCl), lithium iodide (LiI), lithium nitrate (LiNO₃), calcium chloride (CaCl₂), and potassium nitrate (KNO₃). The acid concentration ranges between 0 to 100 wt. % and the metal salt concentration ranges between 0 g/L to its saturation concentration in solution. In a non-limiting embodiment, the acid of the lanthanide strip solution is hydrochloric acid and the metal salt is magnesium chloride. The acid (e.g., hydrochloric acid) concentration in the lanthanide strip solution typically ranges between about 0 to 12 mol/L, more typically is in the range of about 0 to 8 mol/L, more typically is in the range of about 0 to 6 mol/L, more typically is in the range of about 0 to 3 mol/L, more typically is in the range of about 0 to 1 mol/L, and even more typically is in the range of about 0 to 0.5 mol/L. Stated differently, the acid (e.g., hydrochloric acid) concentration is typically less than about 12 mol/L, more typically less than about 8 mol/L, more typically less than about 6 mol/L, more typically less than about 3 mol/L, even more typically less than about 1 mol/L, and even more typically less than about 0.5 mol/L. The metal salt (e.g., magnesium chloride) concentration in the lanthanide strip solution typically ranges between about 0 mol/L to its saturation point (at room temperature), or more precisely is in the range of about 0 to 6 mol/L, more typically is in the range of about 0 to 4 mol/L, more typically is in the range of about 0 to 2 mol/L, even more typically is in the range of about 0 to 1 mol/L, and even more typically is in the range of about 0 to 0.5 mol/L. Stated differently, the metal salt (e.g., magnesium chloride) concentration is typically less than about 6 mol/L, more typically less than about 4 mol/L, more typically less than about 3 mol/L, more typically less than about 2 mol/L, more typically less than about 1 mol/L, and even more typically less than about 0.5 mol/L.

The precipitation agent [7] and [17], described with reference to any of FIGS. 1 to 4, is a base, alkali or alkali-earth salt or solution (e.g., as ammonium, sodium, potassium, magnesium and calcium oxide, hydroxide or carbonate) which reacts with the transition metal in solution and precipitates the transition metals out of solution. In one non-limiting embodiment, highly reactive magnesium oxide is utilized as the precipitation agent in [7] and/or [17].

The lanthanide extractant [21], as described with reference to any of FIGS. 1 to 4, is an extractant which extracts the lanthanides from the scrub solution and is determined based on system specifications. Examples of such extractants include but are not limited to the DGA, Di(2-ethylhexyl) phosphoric acid (D2EHPA), 2-Ethylhexyl Phosphonic Acid Mono-2-ethylhexyl (EHEHPA), Cyanex 572, etc.

The extraction units [A] and [G], lanthanide scrub unit [D], and stripping units [B] and [E] of any of FIGS. 1 to 4, can be undertaken in any equipment allowing for a mixing of the phase followed by a phase separation. Example of these units include but are not limited to mixer-settlers and combinations of agitated tanks and settlers. Any number of such equipment may be configured in series or parallel as is well known to person having ordinary skill in the art.

The precipitation units [C] and [F], of any of FIGS. 1 to 4, can be undertaken in any agitated vessel, reactor or equipment commonly used in the industry for such application, with or without dewatering and phase separation units included.

As will be appreciated by a skilled metallurgist, the exact composition of the Acidic Feed material would favor one of the processes disclosed herein.

Units [A] through [E] are representations of one or more physical equipment units and/or representations of method steps. Unit [A] through [E] and/or streams [1]-[22] may be the same or different across FIGS. 1-4.

The present disclosure additionally provides processes and methods for the use of selective bulk extraction of lanthanide(s) by using a TBP extractant. A TBP circuit of the present disclosure may selectively remove iron from an organic phase comprising lanthanide(s). In an embodiment, the TBP may include one or more extraction units [H] in which iron, lanthanides, thorium, and other metals are extracted to an organic phase from an acid feed solution. The acidic phases (e.g., the solutions comprising the rare earth elements and other metals in solution) can be an aqueous phase, a polar molecular non-aqueous phase or an ionic liquid phase, but should not be miscible with TBP. Acids in the acidic phases can include but are not limited to one of, or a combination of the following inorganic acids: hydrochloric acid, nitric acid, sulfuric acid, phosphoric acid and/or organic acids such as acetic acid, citric acid or lactic acid.

The organic solution may be directed to one or more lanthanide scrubbing units [I] of the TBP circuit, wherein lanthanide(s), scandium, and thorium are removed (e.g., stripped, scrubbed) from the organic phase into a scrub solution. The organic phase (stripped or scrubbed of the lanthanide(s), scandium, and thorium) may be directed to one or more iron strip units [J] of the TBP circuit, where iron is selectively removed (e.g., stripped, scrubbed) from the organic phase into an iron strip solution.

The organic phase can be an organic phase or an ionic liquid phase and may be composed of a TBP extractant, and a combination of modifiers and diluents. Modifiers can include one or a mixture of alcohol and ethers. In an embodiment, the organic phase may comprise about 100% TBP with no modifier. In some embodiments, the organic phase may comprise about 0 to 60% modifier, or more preferably about 0 to 50% modifier, or more preferably about 0 to 40% modifier, or more even more preferably about 0 to 30% modifier. Diluents included in the organic phase can include one or a mixture of aliphatic or aromatic hydrocarbons or one or a mixture of ionic liquids. In an embodiment, the organic phase may comprise 100% TBP with no diluent. In some embodiments, the organic phase may comprise 0 to 80% diluent, or more preferably about 0 to 70%, or more preferably about 0 to 60% diluent. In some embodiments, the organic phase may comprise about 50-90% TBP, or more typically about 60-85% TBP, about 10-20% modifier, or more typically about 15% modifier, with the remaining balance being diluent (to reach 100%).

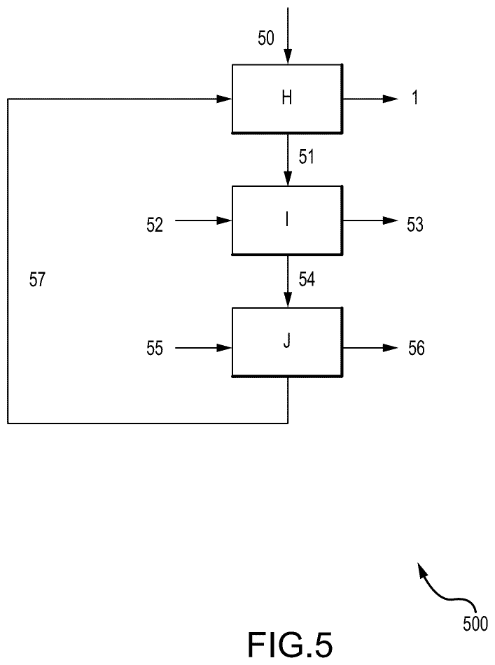

Embodiments of TBP circuit is described in further detail with reference to FIG. 5. Although, it should be understood that the TBP circuit described with reference to FIG. 5 is provided as an example and a TBP circuit of the present disclosure may include all or a portion of units [H] to [J], arranged in any combination. A TBP circuit of the present disclosure may include multiples of one or more of units [H] to [J], and/or may include additional units not depicted and/or defined by units [H] to [J]. It should be understood that a TBP circuit of the present disclosure is not limited to the example provided herein.

FIG. 5 illustrates a process flow schematic 500 utilizing a TPB extractant according to an embodiment of the disclosure. The process flow schematic 500 includes an extraction unit circuit [H], a lanthanide scrubbing unit [I], and an iron strip unit [J].

In process flow schematic 500, an acidic feed solution typically comprising from transition metals (e.g., iron), lanthanide(s), and thorium is contacted with a recycled TBP

extractant in the extraction unit [H] and the resulting mixture is phase separated into

raffinate [1] and loaded organic [51]. The acidic feed solution typically comprises iron in ranges of about 10 to 35 g/L, or more particularly in ranges of about 15 to 30 g/L, or even more particularly in ranges of about 16 to 25 g/L. The acidic feed solution additionally typically comprises scandium (in ranges of about 0 to 30 mg/L, or more particularly in ranges of about 0 to 25 mg/L, or even more particularly in ranges of about 5 to 20 mg/L), dysprosium (in ranges of about 0 to 30 mg/L, or more particularly in ranges of about 0 to 25 mg/L, or even more particularly in ranges of about 0 to 15 mg/L), and thorium (in ranges of about 0 to 100 mg/L, or more particularly in ranges of about 0 to 80 mg/L, or even more particularly in ranges of about 20 to 60 mg/L).

The raffinate [1] comprises little or no iron (e.g., less than 20%, less than about 10%, less than about 5%, less than about 1% of the raffinate [1] is composed of iron). Stated differently, the raffinate comprises less than about 100 mg/L iron, or more particularly less than about 50 mg/L iron, or more particularly less than about 10 mg/L iron, or more particularly less than about 5 mg/L iron, or even more particularly less than about 1 mg/L iron. The raffinate [1] may comprise small amounts of scandium (e.g., less than about 5 mg/L, less than about 3 mg/L, less than about 1 mg/L), dysprosium (less than about 20 mg/L, less than about 10 mg/L, or in the range of about 0 to 20 mg/L, in the range of about 3 to 10 mg/L, in the range of about 4 to mg/L), and thorium (less than about 70 mg/L, less than about 25 mg/L, less than about 10 mg/L). The raffinate [1] is sent to a different portion of the process for further processing. In one embodiment, the raffinate [1] is directed as an input to a DGA circuit of the present disclosure, such as any one of the DGA circuits represented by FIGS. 1 to 4.

The loaded organic is selectively stripped of at least most of the remaining lanthanide(s) and thorium in the lanthanide scrub stage [I] using the lanthanide strip solution [52]. The stripped compounds may comprise scandium (between about 0 and 10 mg/L), thorium (between about 0 and 200 mg/L), small amounts of zinc, small amount of iron (less than about 5g/L, less than about 3 g/L, less than about 1 g/L), and in some embodiments, lanthanides such as dysprosium (between about 0 and 10 mg/L). At least most (e.g., at least about 70%, at least about 80%, at least about 90%) of the total thorium in the acidic feed solution is output from the TBP circuit via the stripped compounds [53].

The stripped compounds can, in some embodiments, be sent as an input to a DGA circuit of the present disclosure, such as any one of the DGA circuits represented by FIGS. 1 to 4.

The lanthanide stripped organic comprising most of the iron on the loaded organic is then stripped of at least most of the iron using the iron strip solution in the iron strip unit [J]. The resulting iron strip liquor may comprise high amounts of iron (between about 15 to 50 g/L, or 20 to 40 g/L), and small amounts or no scandium, lanthanides, and thorium (less than about 5 mg/L, less than about 1 mg/L).

The resulting iron strip liquor may be sent to a different process stage for further processing. The stripped organic is substantially free of lanthanides, thorium, and transition metals and is recycled to the extraction stage [H].

The lanthanide strip solution [52], described in FIG. 5, may be an acidic phase comprising an acid and a metal salt. Acids in the lanthanide strip solution can include but are not limited to one of, or a combination of the following inorganic acids: hydrochloric acid, nitric acid, sulfuric acid, phosphoric acid and/or organic acids such as acetic acid, citric acid or lactic acid. Metal salts in the lanthanide strip solution can include but are not limited to one or, or a combination of the following: sodium chloride (NaCl), magnesium chloride (MgCl₂), magnesium bromide (MgBr₂), lithium bromide (LiBr), lithium chloride (LiCl), lithium iodide (LiI), lithium nitrate (LiNO₃), calcium chloride (CaCl₂), and potassium nitrate (KNO₃). The acid concentration ranges between 0 to 100 wt. % and the metal salt concentration ranges between 0 g/L to its saturation concentration in solution.

In a non-limiting embodiment, the acid of the lanthanide strip solution is hydrochloric acid. The acid (e.g., hydrochloric acid) concentration in the lanthanide strip solution typically ranges between about 0 to 12 mol/L, more typically is in the range of about 0 to 8 mol/L, more typically is in the range of about 0 to 6 mol/L, more typically is in the range of about 1 to 5 mol/L, and even more typically is in the range of about 1 to 3 mol/L.

In a non-limiting embodiment, no metal salt is used in the lanthanide strip solution or the metal salt is magnesium chloride. The metal salt (e.g., magnesium chloride) concentration in the lanthanide strip solution typically ranges between about 0 mol/L to its saturation point (at room temperature), or more precisely is in the range of about 0 to 6 mol/L, more typically is in the range of about 0 to 4 mol/L, more typically is in the range of about 0 to 3 mol/L, even more typically is in the range of about 0 to 1 mol/L, and even more typically is in the range of about 0 to 0.5 mol/L. Stated differently, the metal salt (e.g., magnesium chloride) concentration is typically less than about 6 mol/L, more typically less than about 4 mol/L, more typically less than about 3 mol/L, more typically less than about 2 mol/L, more typically less than about 1 mol/L, and even more typically less than about 0.5 mol/L.

The iron strip solution [55], described in FIG. 5, may be an acidic phase comprising an acid and a metal salt. Acids in the iron strip solution can include but are not limited to one of, or a combination of the following inorganic acids: hydrochloric acid, nitric acid, sulfuric acid, phosphoric acid and/or organic acids such as acetic acid, citric acid or lactic acid. Metal salts in the iron strip solution can include but are not limited to one or, or a combination of the following: sodium chloride (NaCl), magnesium chloride (MgCl₂), magnesium bromide (MgBr₂), lithium bromide (LiBr), lithium chloride (LiCl), lithium iodide (LiI), lithium nitrate (LiNO₃), calcium chloride (CaCl₂), and potassium nitrate (KNO₃). The acid concentration ranges between 0 to 100 wt. % and the metal salt concentration ranges between 0 g/L to its saturation concentration in solution. In a non-limiting embodiment, the acid of the iron strip solution is hydrochloric acid and the metal salt is ferric chloride.

The acid (e.g., hydrochloric acid) concentration in the iron strip solution typically ranges between about 0 to 12 mol/L, more typically is in the range of about 0 to 8 mol/L, more typically is in the range of about 0 to 6 mol/L, more typically is in the range of about 0 to 5 mol/L, more typically is in the range of about 0 to 1 mol/L, and even more typically is in the range of about 0 to 0.5 mol/L. Stated differently, the acid (e.g., hydrochloric acid) concentration is typically less than about 12 mol/L, more typically less than about 8 mol/L, more typically less than about 6 mol/L, more typically less than about 5 mol/L, even more typically less than about 1 mol/L, and even more typically less than about 0.5 mol/L.

The metal salt (e.g., ferric chloride) concentration in the iron strip solution typically ranges between about 0 mol/L to its saturation point (at room temperature), or more precisely is in the range of about 0 to 6 mol/L, more typically is in the range of about 0 to 5 mol/L, more typically is in the range of about 0 to 3 mol/L, even more typically is in the range of about 0 to 1 mol/L, and even more typically is in the range of about 0 to 0.1 mol/L. Stated differently, the metal salt (e.g., ferric chloride) concentration is typically less than about 6 mol/L, more typically less than about 5 mol/L, more typically less than about 4 mol/L, more typically less than about 3 mol/L, more typically less than about 1 mol/L, and even more typically less than about 0.1 mol/L.

The extraction unit [H], scrubbing unit [I] and stripping unit [J] can comprise any equipment allowing for a mixing of the phase followed by a phase separation. Examples of such equipment include but are not limited to mixer-settlers and combinations of agitated tanks and settlers. Many arrangements of such equipment may be configured in series or parallel as is well known to person having ordinary skill in the art.

In embodiments of the present disclosure, one or more of the circuits described herein may be combined to achieve a desired lanthanide recovery, to abide by or achieve particular plant design constraints, etc. For example, one or more DGA circuits may be combined in parallel and/or sequentially. Similarly, one or more TBP circuits may be combined in parallel and/or sequentially. One or more DGA circuits may be combined with one or more TBP circuits.

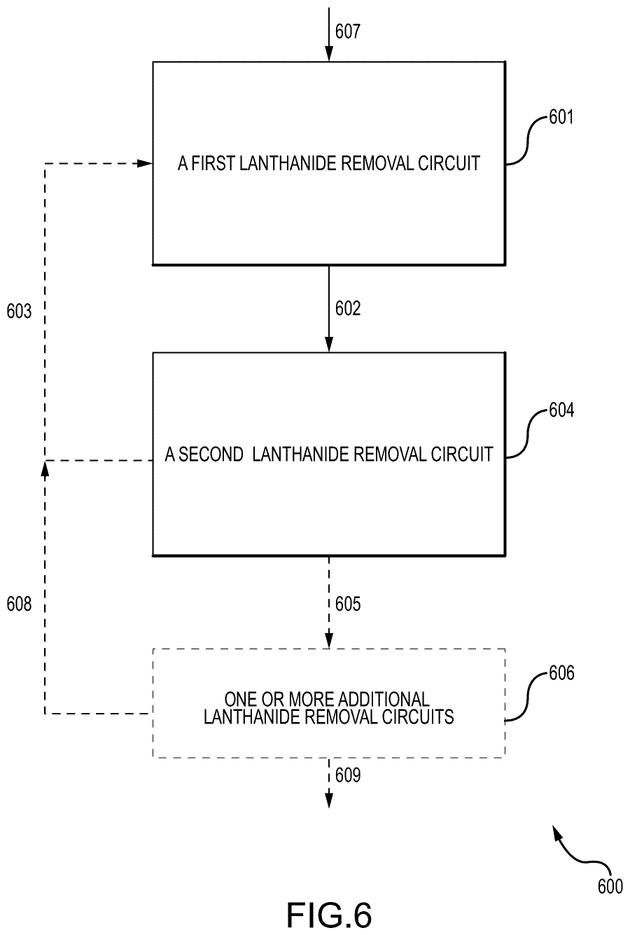

FIG. 6 illustrates a process flow schematic 600 utilizing one or more DGA extractants and/or one or more TBP extractants according to an embodiment of the disclosure. The process flow schematic 600 includes a first lanthanide removal circuit 601, a second lanthanide removal circuit 602, and optionally one or more additionally lanthanide removal circuits 606.

The first lanthanide removal circuit 601 may include any one more TBP circuits described herein or similar, and/or any one or more DGA circuits described herein or similar. The second lanthanide removal circuit 602 may include any one or more TBP circuits described herein or similar, and/or any one or more DGA circuits described herein or similar. The first lanthanide removal circuit 601 may receive one or more input streams 607 (e.g., a PLS), 603, and/or 608 comprising lanthanides and/or transition metals. The output 602 of the first lanthanide removal circuit 601 may be used as an input to the second lanthanide removal circuit 602. Similarly, the output 605 of the second lanthanide removal circuit 602 may be used as an input to one or more additional lanthanide removal circuits 606. In some cases, an output of any one or more of the circuits, such as output 609 may be sent to one or more additional processes for further processing. In some embodiments, one or more outputs from one or more of the circuits, such as outputs 603 and 608, may be recycled and input to one or more other circuits.

In a non-limiting embodiment, the TBP circuit of FIG. 5 may be combined with any one of the DGA circuits of FIGS. 1 to 4. For example, the TBP circuit of FIG. 5 may be positioned ahead of the DGA circuit of FIG. 4, where the raffinate [1] and/or the stripped lanthanide and thorium of FIG. 5 may be directed to the DGA circuit of FIG. 4 and used as inputs.

The design of one or more circuits (e.g., the size of each circuit and/or units in each circuit, the number of circuits and/or number of units in each circuit, and orientation of the circuits and/or units in each circuit) aimed at recovering lanthanide(s) may be based on the composition of a starting feed material (e.g., PLS).

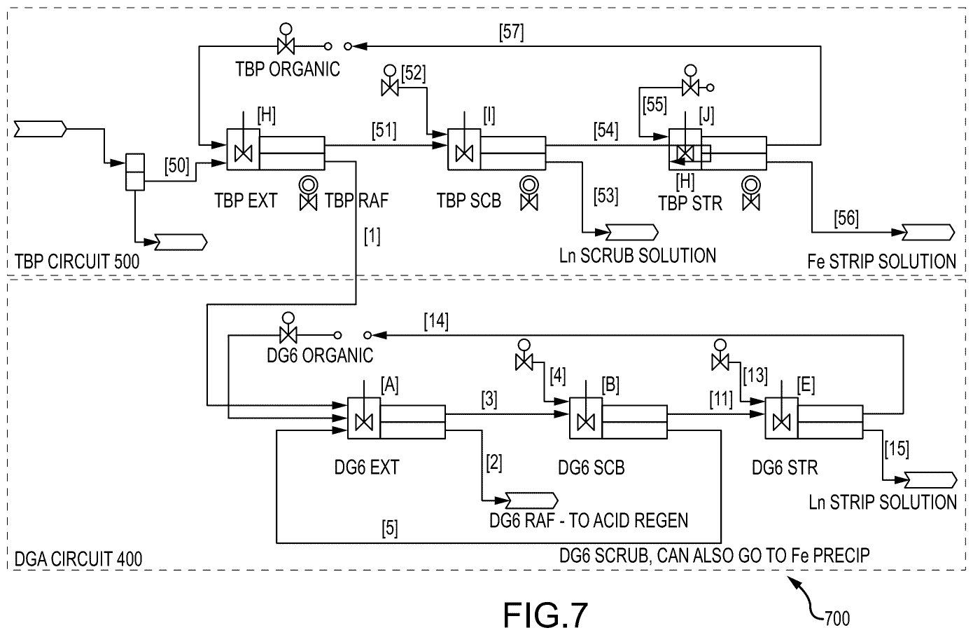

FIG. 7 illustrates a process flow schematic 700 utilizing one or more DGA extractants and/or one or more TBP extractants according to an embodiment of the disclosure. Process flow schematic 700 may be a detailed example of a combination of circuits, such as a TBP circuit 500 and a DGA (e.g., DG6) circuit 400. The TBP circuit 500 may utilize a TBP extractant and the DGA circuit 400 may utilize a DGA extractant may utilize one or combination of DGA extractants, such as DG6. In some embodiments, the DGA extractant utilized in DGA circuit 500 comprises more DG6 over any other DGA extractant.

Particularly, process flow schematic 700 depicts a TBP circuit 500 (as discussed with reference to FIG. 5), and a DGA circuit (as discussed with reference to FIG. 4), wherein an acidic feed solution is fed into the TBP circuit 400. The TBP circuit 500 may selectively separate lanthanides from transition metals, such as iron, in the acidic feed solution [1], as described with reference to FIG. 5. One or more lanthanide-comprising

streams recovered from the TBP circuit (e.g., [1] and/or [53]) may be output from the TBP circuit and sent to one or more other circuits for further processing. For example, lanthanide-comprising stream [1] may be output from the TBP circuit 500 and used as an input to the DGA circuit 400. The DGA circuit 500 may selectively recover the lanthanides from the lanthanide-comprising stream [1] by selectively removing the transition metals from the lanthanide-comprising stream [1]. Accordingly, the DGA circuit may output at least a lanthanide liquor [15], as described with reference to FIG. 4.

### EXAMPLES

### Example A

Example A was the operation of a continuous integrated demonstration unit in a configuration illustrated by FIG. 7. However, in the example described herein, the DG6 Scrub stream [5] is accumulated in a vessel and not recycled to the DG6 extraction circuit.

The TBP PLS was pumped in the fourth mixer-settler of the TBP extraction unit [H] comprised of 4 mixer-settler stages at a rate of about 60 milliliters per minute. The recycled TBP organic was pumped to the first mixer-settler of the TBP extraction unit [H] at a rate of about 30 milliliters per minute. The organic is comprised initially of about 100% TBP. It should be understood that once the circuit 500 reaches its equilibrium, the TBP organic recycle stream will also comprise water, hydrochloric acid and metal chlorides. The TBP raffinate stream [1] was pumped to a vessel where it was accumulated and blended throughout the operation before being used in the DG6 circuit 400.

The loaded TBP organic stream is flown to the first cell of the TBP scrub unit [I] comprised of four mixer settlers in series. The TBP Scrub Solution was pumped to the fourth mixer-settler TBP scrub unit [I] at a rate of about 20 milliliters per minute. The TBP Scrub Solution in this Example A is about a 2 M hydrochloric acid solution in deionized water. Output from the TBP scrub unit [I] is a scrubbed TBP organic stream and a scrub solution [53].

The scrubbed TBP organic stream is flown to the first cell of the TBP strip unit [J] comprised of four mixer settlers in series. The TBP Strip Solution was pumped to the fourth mixer-settler TBP scrub unit [J] at a rate of about 40 milliliters per minute. The TBP Strip Solution in this embodiment is about a 2.0 M hydrochloric acid solution in deionized water. An iron strip solution and the is output from the TBP organic recycle stream is output from the TBP strip unit [J].

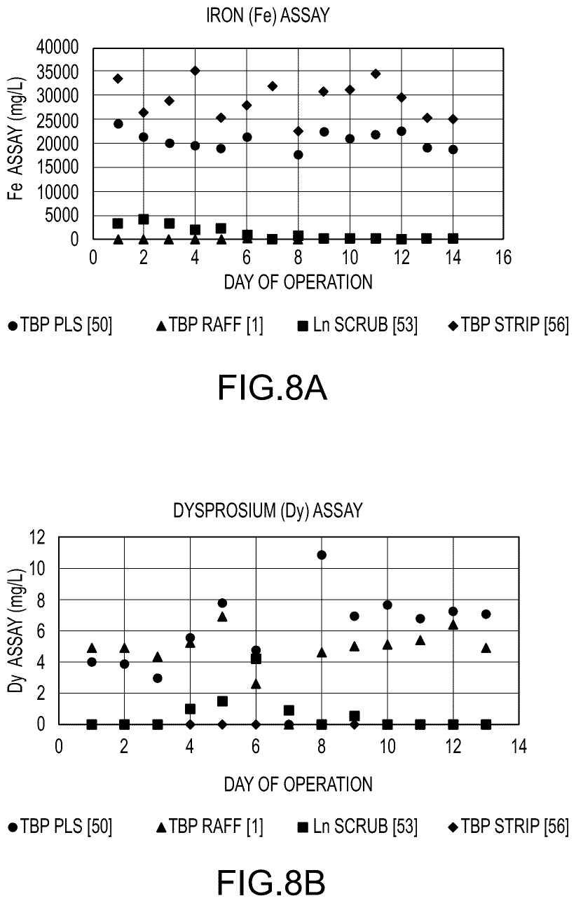

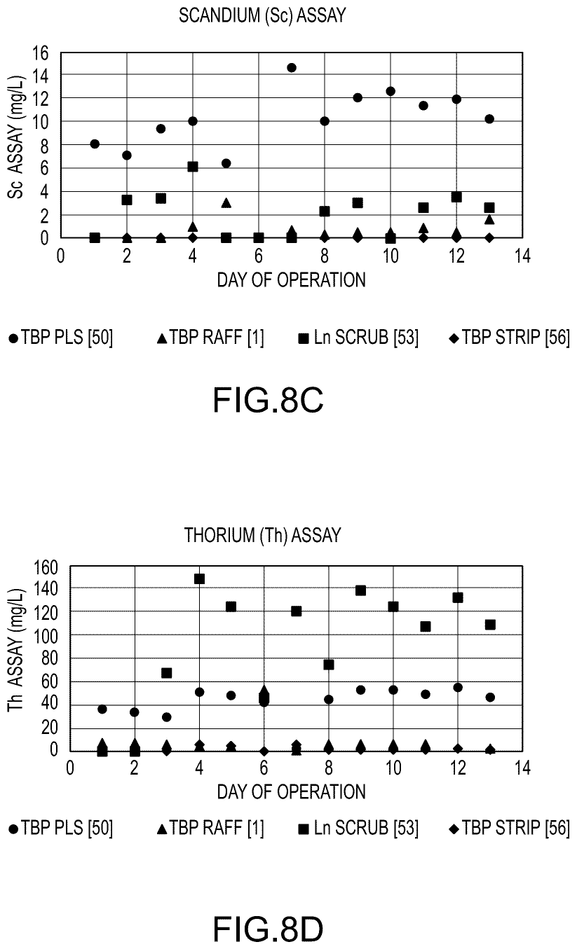

FIGS. 8A to 8D present the composition of selected relevant metals for the TBP circuit in various streams, including streams [50], [1], [53], and [56]. The TBP raffinate (DG6 PLS) [1] was pumped from the blended vessel of unit [H] to the fourth mixer-settler of the DG6 extraction unit [A] comprised of 4 mixer-settler stages at

a rate of about 55 milliliters per minute. The recycled DG6 organic was pumped to the first mixer-settler DG6 extraction unit [A] at a rate of about 20 milliliters per minute. The organic is comprised initially of about 18 vol. % DG6, about 20 vol. % i-tridecyl alcohol, and about 62 vol. % kerosene. It should be understood that once the circuit reaches it equilibrium, the DG6 organic recycle stream will also comprise water, hydrochloric acid and metal chlorides.

The loaded DG6 organic stream [3] (output from unit [A]) is flown to the first cell of the DG6 scrub unit [B] comprised of four mixer settlers in series. The DG6 Scrub Solution [4] was pumped to the fourth mixer-settler DG6 scrub unit [B] at a rate of about 13 milliliters per minute. The DG6 Scrub Solution [4] in this Example A is about a 2 M hydrochloric acid and about 0.5 M magnesium chloride solution in deionized water. A scrubbed DG6 organic stream and a DG6 scrub [6] are output from unit [B]. The scrubbed DG6 organic stream is flown to the first cell of the DG6 strip unit [E] comprised of four mixer settlers in series. The DG6 Strip Solution was pumped to the fourth mixer-settler DG6 scrub unit [E] at a rate of about 20 milliliters per minute. The DG6 Strip Solution in this Example A is about a 0.2 M hydrochloric acid solution in deionized water.

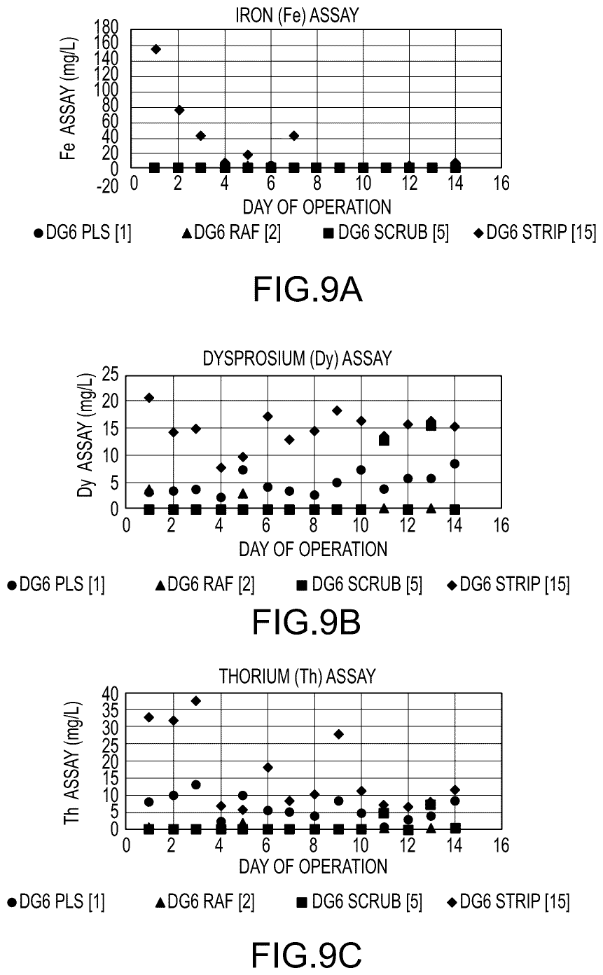

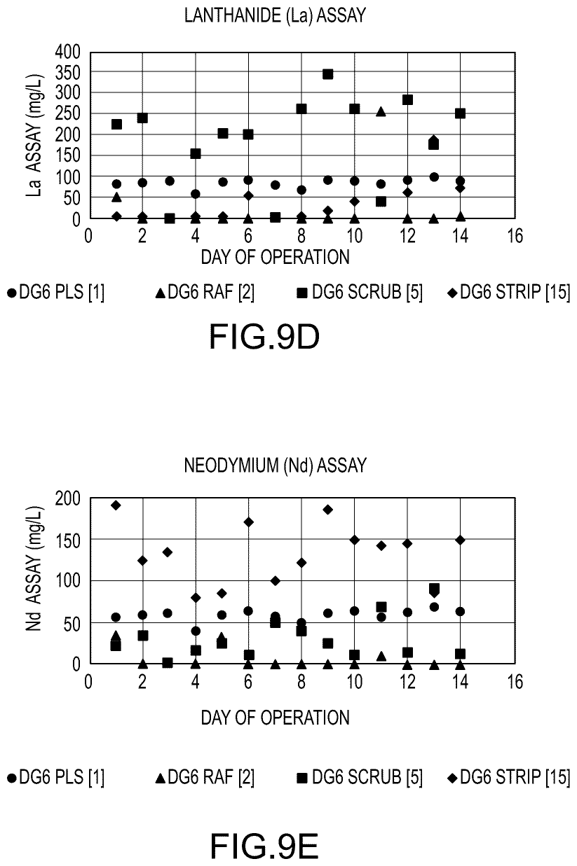

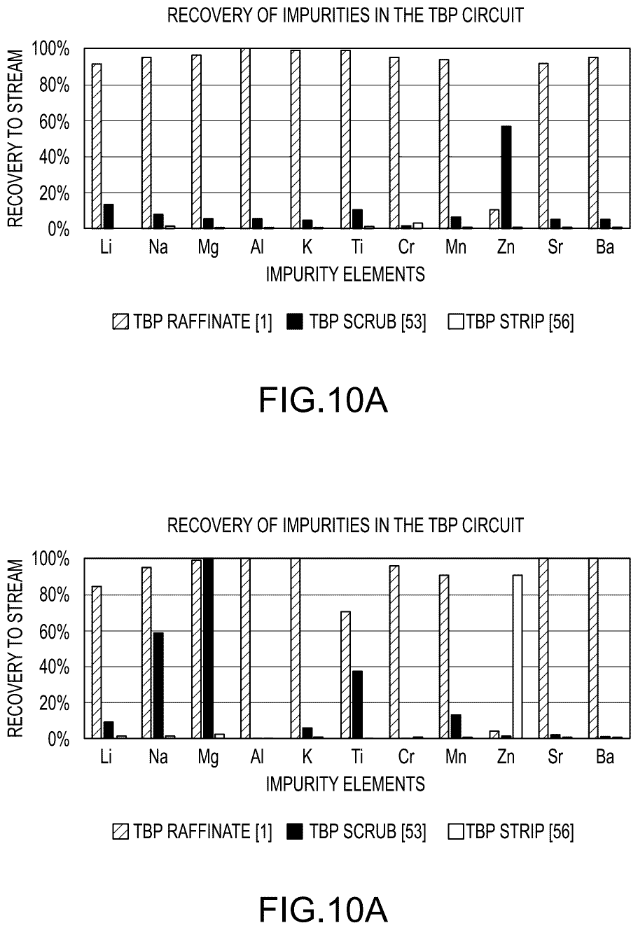

FIGS. 9A to 9E present the composition of selected relevant metals for the DG6 circuit 400 in various streams, including streams [1], [2], [5], and [15]. Additionally, FIGS. 10A and 10B provide the recovery of impurities in the TBP circuit 500 and the DG6 circuit 400, respectively. As can be seen, the combination of the TBP circuit 400 and the DG6 circuit as described herein, result in few impurities (e.g., lithium, sodium, magnesium, potassium, titanium) in the lanthanide liquor [15]. All (or most) impurities, including aluminum, with the exception of zinc are rejected in the raffinate streams.

### Example B

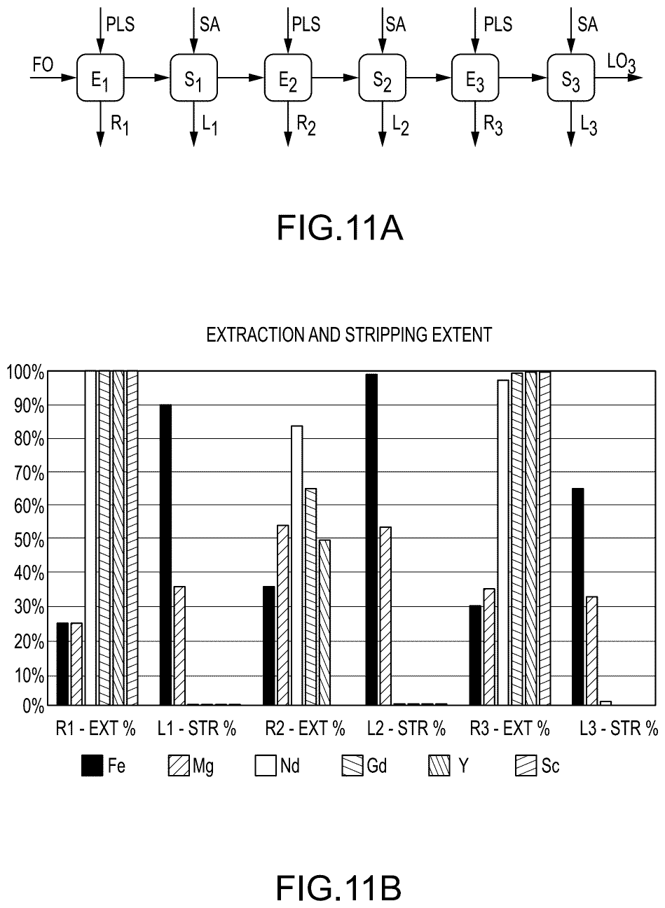

Example B represents a series of three batch extraction (i.e., E₁, E₂, and E₃) and subsequent stripping tests (i.e., S₁, S₂, and S₃) performed on a DMDODGA system, represented by FIG. 11A. In this experiment, the organic phase (FO) is comprised of about 4 vol. % DMDODGA and about 96% 2-ethyl-1-hexanol. The strip solution (SA) is composed of about a 0.01 M HCl and about 0.5 M MgCl₂ solution. The contact time was set at about 30 minutes and the experiments were performed at ambient temperature. Extraction volumes were set at about 100 mL of PLS and about 50 mL of organic. The stripping volumes were set at about 50 mL for both the loaded organic (LO) and the strip solution (SA). The extraction and stripping extents are presented as FIG. 11B.

This experiment B demonstrates that the selective extraction of rare earth elements over iron in the extraction stages (i.e., E₁, E₂, and E₃) and the selective stripping of iron from the loaded organic (LO) with minimum losses of relevant rare earths in the experiment. The experiment demonstrated that magnesium chloride (MgCl₂) is competing directly with iron (III) chloride (FeCl₃) for extraction and that magnesium chloride can be directly substituted in the organic for iron (III) chloride with no rare earth element loses.

### Example C

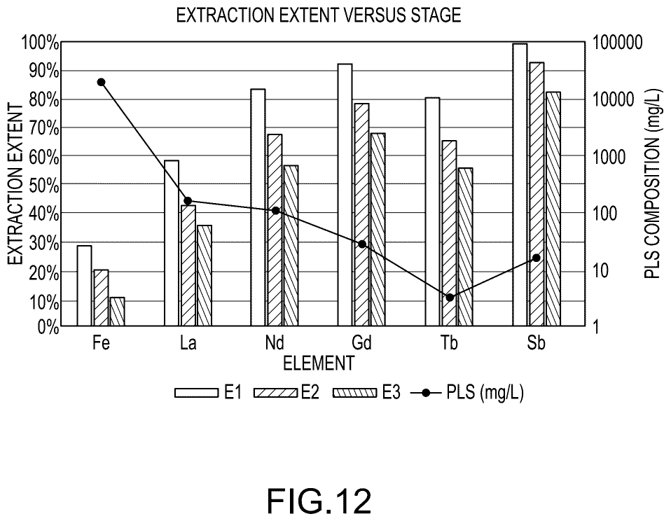

Example C represents a series of three extractions experiments using a single organic phase and three fresh PLS phases. In this experiment, the organic phase is comprised of 25 vol. % DG6, 25 vol. % tridecyl-alcohol and 50 vol. % kerosene. The contact time was set at about 30 minutes and the experiments were performed at ambient temperature. The extraction volumes were set at about 300 mL of PLS and about 50 mL of organic. The extraction extents are presented as FIG. 12. The experiment shows a much higher selectivity for rare earth elements than for iron even if the iron concentration in the feed material is two to three orders of magnitude higher. This can also be observed in the successive extractions where the reduction of extraction extent is much greater for iron than the rare earth elements.

### Example D

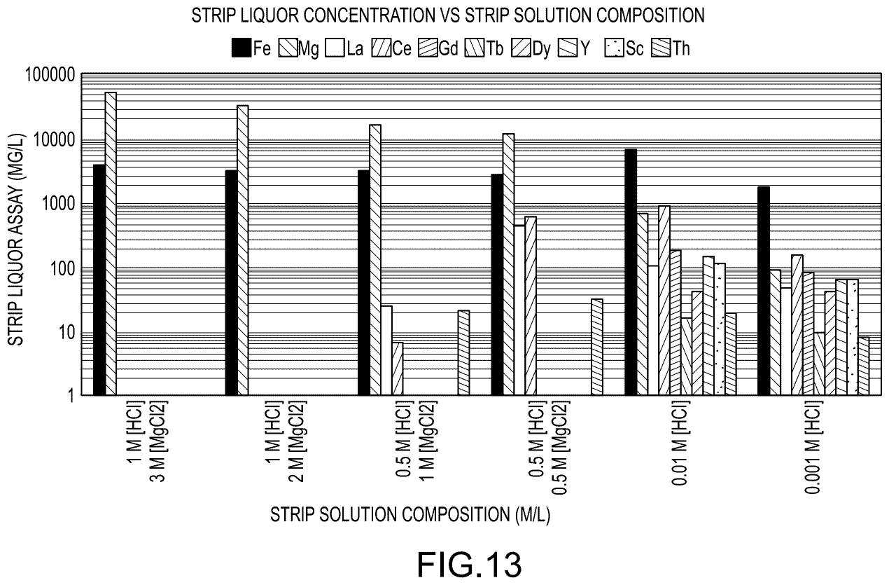

For example D, a series of six stripping experiments were preformed using organic previously loaded using six extractions in series with fresh PLS following the protocol described with reference to Example C. Each stripping experiment was performed using a strip solution of decreasing activity. Strip solution 1 was composed of about 1 M hydrogen chloride (HCl) and about 3 M magnesium chloride (MgCl₂). Strip solution 2 was composed of about 1 M HCl and about 2 M MgCl₂. Strip solution 3 was composed of about 0.5 M HCl and about 1 M MgCl₂. Strip solution 4 was composed of about 0.5 M HCl and about 0.5 M MgCl₂. Strip solution 5 was composed of about 0.01 M HCl. Strip solution 6 was composed of about 0.001 M HCl. Stripping volumes were set at approximately (or exactly) equal volumes of strip solution and of loaded organic. The contact time was set at about 30 minutes and the experiments were performed at about ambient temperature. The strip liquor compositions resulting from each of strip solutions 1 to 6 are shown in FIG. 13. The result of the experiment demonstrates that iron can be selectively scrubbed without loses of rare earth element by controlling the MgCl₂ composition of the strip solution above 2 M/L. It is also possible to selectively scrub iron, lanthanum, cerium and thorium from the organic by adjusting the strip solution MgCl₂ composition to about 0.5 M/L to 1 M/L. Stated differently, as the concentration of magnesium is decreased, the rare earth element stripping is increased. Therefore, if the magnesium is included in the stripping solution at particular concentrations, then iron can be selectively removed, and while leaving the rare earth elements in solution. A number of variations and modifications of the disclosure can be used. It would be possible to provide for some features of the disclosure without providing others. The present disclosure, in various embodiments, configurations, or aspects, includes components, methods, processes, systems and/or apparatus substantially as depicted and described herein, including various embodiments, configurations, aspects, subcombinations, and subsets thereof. Those of skill in the art will understand how to make and use the present disclosure after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A method, comprising:
step (a) contacting an organic solution comprising one or more rare earth elements and one or more of base metals and thorium with an acidic solution to selectively remove at least most of the base metals and thorium to form a base metal-rich acidic solution and a base metal-scrubbed organic solution comprising the rare earth elements; and
step (b) contacting the base metal-rich acidic solution with a precipitation agent to remove at least most of the base metals and thorium to form a base metal-stripped acidic solution and solids comprising the base metals and thorium.

2. The process of claim 1, further comprising:
recycling, to step (a), the base metal-stripped acidic solution for at least partial use as the acidic solution.

3. The process of claim 1, wherein at least most of the rare earth elements from the organic solution are maintained in the base metal-scrubbed organic solution after the contacting of step (a).

4. The process of claim 1, wherein the base metal-scrubbed organic solution is substantially free of the one or more of base metals and thorium.

5. The process of claim 1, wherein the acidic solution comprises one or more alkali compounds, the one or more alkali compounds comprising sodium, potassium, magnesium, calcium, strontium, ammonium, or combinations thereof.

6. The process of claim 5, wherein the one or more alkali compounds are in the form of a salt, and wherein the salt is a chloride or a nitrate salt selected from the group comprising magnesium chloride, calcium chloride, strontium chloride, ammonium chloride, sodium chloride, magnesium nitrate, calcium nitrate, strontium nitrate, ammonium nitrate, sodium nitrate, or combinations thereof.

7. The process of claim 1, wherein the precipitation agent is an alkali compound comprising sodium, potassium, magnesium, calcium, strontium or ammonium.

8. The process of claim 7, wherein the precipitation agent is a carbonate, an oxide, a hydroxide, or an oxychloride.

9. The process of claim 1, further comprising:
contacting, prior to step (a), a pregnant leach solution comprising the rare earth elements with a diglycoamide (DGA) extractant to form a raffinate and the organic solution, wherein the organic solution comprises at least most of the rare earth elements from the pregnant leach solution.

10. The process of claim 1, wherein the rare earth elements comprise yttrium, terbium, europium, thulium, ytterbium, praseodymium, dysprosium, gadolinium, lutetium, promethium, scandium, neodymium, samarium, erbium, holmium, or combinations thereof.

11. The process of claim 1, wherein the base metals comprise iron (Fe), titanium (Ti), niobium (Nb), vanadium (V), chromium (Cr), cobalt (Co), nickel (Ni), zirconium (Zr), aluminum (Al), or combinations thereof.

12. A method, comprising:
step (a) contacting an organic solution comprising one or more lanthanides and one or more of base metals and thorium with an alkali comprising solution to selectively remove at least most of the base metals and thorium to form a base metal-rich alkali comprising solution and a base metal-scrubbed organic solution comprising the lanthanides;
step (b) contacting the base metal-rich alkali comprising solution with a precipitation agent to form a base metal-stripped alkali comprising solution and solids comprising the base metals and thorium; and
step (c) recycling, to step (a), the base metal-stripped alkali comprising solution.

13. The process of claim 12, wherein, in step (b), at least most of the base metals and thorium of the base metal-rich solution are precipitated into the solids.

14. The process of claim 12, wherein at least most of the lanthanides from the organic solution are maintained in the base metal-scrubbed organic solution after the contacting of step (a).

15. The process of claim 12, wherein at least a portion of the alkali comprising solution in step (a) comprises the base metal-stripped alkali comprising solution recycled from step (c).

16. The process of claim 12, wherein the alkali comprising solution comprises one or more alkali compounds, the one or more alkali compounds comprising sodium, potassium, magnesium, calcium, strontium, ammonium, or combinations thereof, and
wherein the one or more alkali compounds are in the form of a chloride or nitrate salt, selected from the group comprising magnesium chloride, calcium chloride, strontium chloride, ammonium chloride, sodium chloride, magnesium nitrate, calcium nitrate, strontium nitrate, ammonium nitrate, sodium nitrate, or combinations thereof.

17. The process of claim 12, further comprising:
contacting, prior to step (a), a pregnant leach solution comprising the lanthanides with a diglycoamide (DGA) extractant to form a raffinate and the organic solution, wherein the organic solution comprises at least most of the lanthanides from the pregnant leach solution.

18. A method, comprising:
step (a) contacting an organic solution comprising one or more rare earth elements and one or more of base metals and thorium with a first alkali-comprising solution to selectively remove at least most of the base metals and thorium to form a base metal-rich alkali solution and a base metal-scrubbed organic solution comprising the rare earth elements;
step (b) contacting the base metal-rich alkali solution with a precipitation agent to remove at least most of the base metals and thorium to form a base metal-stripped alkali solution and solids comprising the base metals and thorium;
step (c) recycling, to step (a), the base metal-stripped alkali solution; and
step (d) contacting the base metal-scrubbed organic solution with a rare earth stripping solution comprising a second alkali-comprising solution to remove at least most of the rare earth elements from the base metal-scrubbed organic solution.

19. The process of claim 18, wherein at least most of the rare earth elements from the organic solution are maintained in the base metal-scrubbed organic solution after the contacting of step (a).

20. The process of claim 18, wherein at least a portion of the first alkali-comprising solution in step (a) comprises the base metal-stripped alkali solution recycled from step (c).

21. The process of claim 18, wherein the first and/or second alkali-comprising solutions comprises sodium, potassium, magnesium, calcium, strontium or ammonium and are in the form of a salt,
wherein the salt is a chloride or a nitrate salt such as magnesium chloride, calcium chloride, strontium chloride, ammonium chloride, sodium chloride, magnesium nitrate, calcium nitrate, strontium nitrate, ammonium nitrate, sodium nitrate, or combinations thereof, and
wherein the first and second alkali-comprising solutions are the same.

22. The process of claim 18, further comprising:
contacting, prior to step (a), a pregnant leach solution comprising the rare earth elements with a diglycoamide (DGA) extractant to form a raffinate and the organic solution, wherein the organic solution comprises at least most of the rare earth elements from the pregnant leach solution.
